(19) United States
(12) Patent Application Publication
(10) Pub. No.: US 2013/0177077 A1
(43) Pub. Date: Jul. 11, 2013

(54) Method, Apparatus and Computer Program Product for Encoding Video Data

(71) Applicants: Chuohao Yeo, Singapore (SG); Yih Han Tan, Singapore (SG); Zhengguo Li, Singapore (SG); Susanto Rahardja, Singapore (SG)

(72) Inventors: Chuohao Yeo, Singapore (SG); Yih Han Tan, Singapore (SG); Zhengguo Li, Singapore (SG); Susanto Rahardja, Singapore (SG)

(73) Assignee: AGENCY FOR SCIENCE, TECHNOLOGY AND RESEARCH, Singapore (SG)

(21) Appl. No.: 13/809,992

(22) PCT Filed: Jul. 8, 2011
(86) PCT No.: PCT/SG2011/000245

§ 371 Date: Mar. 22, 2013

Related U.S. Application Data
(60) Provisional application No. 61/364,441, filed on Jul. 15, 2010.
(60) Provisional application No. 61/430,572, filed on Jan. 7, 2011.

(51) Int. Cl. H04N 7/26

(52) U.S. Cl. CPC H04N 19/00781
USPC 375/240.12

(57) ABSTRACT

According to various embodiments, a method for encoding video data, and a corresponding apparatus and computer program product. The method includes: applying one of a first transform and a second transform to at least one row of a pixel block, and applying one of the first transform and the second transform to at least one column of the pixel block, based on a prediction mode of the pixel block, to transform between residual pixel values of the pixel block and residual transform coefficients of the pixel block. The method also includes: encoding the residual transform coefficients of the pixel block to generate encoded video data.

### CROSS-REFERENCE TO RELATED APPLICATION

This application claims the benefit of priority of U.S. of America patent application No. 61/364,441, filed 15 Jul. 2010, the content of it being hereby incorporated by reference in its entirety for all purposes. This application claims the benefit of priority of U.S. of America patent application No. 61/430,572, filed 7 Jan. 2011, the content of it being hereby incorporated by reference in its entirety for all purposes.

### TECHNICAL FIELD

Various embodiments relate to a method, apparatus and computer program product for encoding video data.

### BACKGROUND

Video data, such as, for example, moving pictures, may be transmitted from one device to another device. For example, a film clip may be transmitted over the internet from one computing device to another computing device. It is known to encode the video data during transmission, for example, in order to compress the quantity of data transmitted. Compressing data can reduce the amount of data transmitted and thereby reduce the time taken to transmit the film clip between the computing devices.

Various forms of video encoding are known. Some video encoding methods use intra frame prediction to compress video data. In intra frame prediction, a block of the pixels of one frame of video data is predicted using other pixels in the frame. Accordingly, spatial redundancy within a single frame can be reduced. For example, a constant texture or surface in a frame may comprise substantially the same pixel value over a majority of its area. Rather than individually encoding each pixel value, the frame can be encoded taking this redundancy into account. Therefore, the entire surface may be represented by a comparatively small number of pixel values.

### SUMMARY

In various embodiments, a method for encoding video data, the method including: applying one of a first transform and a second transform to at least one row of a pixel block, and applying one of the first transform and the second transform to at least one column of the pixel block, based on a prediction mode of the pixel block, to transform between residual pixel values of the pixel block and residual transform coefficients of the pixel block; and encoding the residual transform coefficients of the pixel block to generate encoded video data.

In various embodiments, an apparatus for encoding video data, the apparatus including: a transformer configured to apply one of a first transform and a second transform to at least one row of a pixel block, and apply one of the first transform and the second transform to at least one column of the pixel block, based on a prediction mode of the pixel block, to transform between residual pixel values of the pixel block and residual transform coefficients of the pixel block; and an encoder configured to encode the residual transform coefficients of the pixel block to generate encoded video data.

In various embodiments, a computer program product comprising at least one computer-readable storage medium having computer-executable program code instructions stored therein, the computer-executable program code instructions comprising: program code instructions for applying one of a first transform and a second transform to at least one row of a pixel block, and applying one of the first transform and the second transform to at least one column of the pixel block, based on a prediction mode of the pixel block, to transform between residual pixel values of the pixel block and residual transform coefficients of the pixel block; and program code instructions for encoding the residual transform coefficients of the pixel block to generate encoded video data.

### BRIEF DESCRIPTION OF THE DRAWINGS

In the drawings, like reference characters generally refer to like parts throughout the different views. The drawings are not necessarily to scale, emphasis instead generally being placed upon illustrating the principles of some embodiments of the invention. In the following description, various embodiments of the invention are described with reference to the following drawings, in which:

FIG. 1 illustrates an encoder,

FIG. 2 illustrates possible intra prediction modes;

FIG. 3 illustrates the operation of the encoder of FIG. 1;

FIG. 4 illustrates the operation of some aspects of FIG. 1 in more detail;

FIG. 5 illustrates a pixel block labeling scheme;

FIG. 6 summarizes the operation of an embodiment;

FIGS. 7 and 8 illustrate experimental results relating to a first set of experiments;

FIGS. 9 to 14 illustrate experimental results relating to a second set of experiments;

FIG. 15a summarizes the operation of an embodiment, FIG. 15b illustrates corresponding possible intra prediction modes and FIG. 15c illustrates how to identify prediction modes using FIG. 15b; and

FIG. 16 illustrates experimental results relating to a third set of experiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

In various embodiments, a method for encoding video data, the method including: applying one of a first transform and a second transform to at least one row of a pixel block, and applying one of the first transform and the second transform to at least one column of the pixel block, based on a prediction mode of the pixel block, to transform between residual pixel values of the pixel block and residual transform coefficients of the pixel block; and encoding the residual transform coefficients of the pixel block to generate encoded video data.

In an embodiment, the transform applied to the at least one row is different to the transform applied to the at least one column based on the prediction mode of the pixel block.

In an embodiment, the first transform is applied to the at least one column and the second transform is applied to the at least one row when the prediction mode of the pixel block is: Mode 0—Vertical, Mode 3—Diagonal down-left, Mode 7—Vertical-left or VER to VER+8 mode.

In an embodiment, the second transform is applied to the at least one column and the first transform is applied to the at least one row when the prediction mode of the pixel block is: Mode 1—Horizontal, Mode 8—Horizontal-up or HOR to HOR+8 mode.

In an embodiment, the first transform is applied to the at least one column and the at least one row when the prediction mode of the pixel block is: Mode 4—Diagonal down-right, Mode 5—Vertical-right, Mode 6—Horizontal-down, VER-8 to VER-1 mode or HOR-7 to HOR-1 mode.

In an embodiment, the second transform is applied to the at least one column and the at least one row when the prediction mode of the pixel block is: Mode 2—DC.

In an embodiment, the first transform is a discrete sine transform.

In an embodiment, the first transform is a Karhunen-Loeve transform.

In an embodiment, the Karhunen-Loeve transform comprises the following matrix:

$${K}_{i , j}^{N} = {[ \frac{2}{\sqrt{2 N + 1}} sin ( \frac{( 2 i - 1 ) j π}{2 N + 1} ) ]}_{i , j}^{N}$$

where 1≦i, j≦N and the pixel block comprises N rows and/or N columns. In an embodiment, the pixel block comprises N rows and M columns, wherein N is different from M. In an embodiment, the pixel block comprises N rows and the Karhunen-Loeve transform matrix is applied to each of the N rows. In an embodiment, the pixel block comprises N columns and M rows, wherein N is different from M. In an embodiment, the pixel block comprises N columns and the Karhunen-Loeve transform matrix is applied to each of the N columns. In an embodiment, the pixel block comprises N rows and N columns. In an embodiment, the pixel block comprises N rows and N columns and the Karhunen-Loeve transform matrix is applied to each of the N rows and N columns.

In an embodiment, the Karhunen-Loeve transform comprises the following matrix:

$${\hat{K}}_{i , j}^{N} = round ( {F}_{1} \times {[ \frac{2}{\sqrt{2 N + 1}} sin ( \frac{( 2 i - 1 ) j π}{2 N + 1} ) ]}_{i , j}^{N} )$$

where 1≦i, j≦N, N, F₁ is a scale factor and the pixel block comprises N×N pixels. In an embodiment, N=4 and 11.43≦F₁≦12.83. In an embodiment, F₁ is 128 when N=4. In an embodiment, F₁ is 128\sqrt{2}≈181 when N=8. In an embodiment, F₁ is 256 when N=16. In an embodiment, F₁ is 256\sqrt{2}≈362 when N=32.

In an embodiment, the Karhunen-Loeve transform comprises the following matrix:

$${\tilde{K}}_{i , j}^{N} = round ( {F}_{2} \times {[ \frac{2}{\sqrt{2 N + 1}} sin ( \frac{( 2 i - 1 ) j π}{2 N + 1} ) ]}_{i , j}^{N} )$$

where 1≦i, j≦N, F₂ is a scale factor and the pixel block comprises N×N pixels. In an embodiment N=4 and 1.17≦F₂≦2.19. In an embodiment, F₂ is 128 when N=4. In an embodiment, F₂ is 128\sqrt{2}≈181 when N=8. In an embodiment, F₂ is 256 when N=16. In an embodiment, F₂ is 256\sqrt{2}≈362 when N=32.

In an embodiment, the Karhunen-Loeve transform comprises:

$$( \begin{matrix}29 & 55 & 74 & 84 \\ 74 & 74 & 0 & - 74 \\ 84 & - 29 & - 74 & 55 \\ 55 & - 84 & 74 & - 29\end{matrix} )$$

In an embodiment, the Karhunen-Loeve transform comprises:

$$( \begin{matrix}3 & 5 & 7 & 8 \\ 7 & 7 & 0 & - 7 \\ 8 & - 3 & - 7 & 5 \\ 5 & - 8 & 7 & - 3\end{matrix} )$$

In an embodiment, the Karhunen-Loeve transform comprises:

$$( \begin{matrix}0 & 1 & 1 & 1 \\ 1 & 1 & 0 & - 1 \\ 1 & 0 & - 1 & 1 \\ 1 & - 1 & 1 & 0\end{matrix} )$$

In an embodiment, the second transform is a discrete cosine transform.

In an embodiment, the discrete cosine transform comprises:

$$( \begin{matrix}64 & 64 & 64 & 64 \\ 84 & 35 & - 35 & - 84 \\ 64 & - 64 & - 64 & 64 \\ 35 & - 84 & 84 & - 35\end{matrix} )$$

In an embodiment, the method further comprises storing the first transform and the second transform for use in transforming between the residual pixel values of the pixel block and the residual transform coefficients of the pixel block.

In an embodiment, the method further comprises quantizing the residual transform coefficients before encoding the residual transform coefficients.

In an embodiment, the method further comprises generating the pixel block by determining the difference between an original pixel block and a predicted pixel block, the predicted pixel block being a prediction of the original pixel block and being generated using the prediction mode.

In an embodiment, the method further comprises processing a video signal to generate the original pixel block.

In an embodiment, the pixel block is a residual pixel block.

In various embodiments, an apparatus for encoding video data, the apparatus including: a transformer configured to apply one of a first transform and a second transform to at least one row of a pixel block, and apply one of the first transform and the second transform to at least one column of the pixel block, based on a prediction mode of the pixel block, to transform between residual pixel values of the pixel block and residual transform coefficients of the pixel block; and an encoder configured to encode the residual transform coefficients of the pixel block to generate encoded video data.

In various embodiments, the any one or combination of the above-described further features of the method are equally applicable to the apparatus.

In various embodiments, a computer program product comprising at least one computer-readable storage medium having computer-executable program code instructions stored therein, the computer-executable program code instructions comprising: program code instructions for applying one of a first transform and a second transform to at least one row of a pixel block, and applying one of the first transform and the second transform to at least one column of the pixel block, based on a prediction mode of the pixel block, to transform between residual pixel values of the pixel block and residual transform coefficients of the pixel block; and program code instructions for encoding the residual transform coefficients of the pixel block to generate encoded video data.

In various embodiments, the any one or combination of the above-described further features of the method are equally applicable to the computer program product.

In the context of various embodiments, a ‘pixel block’ may be understood as a sample of pixels from a frame of a video signal comprising video data, such as, for example, a moving picture. The pixel block may comprise at least one row of pixels and at least one column of pixels. In an embodiment, a pixel block may be a macroblock or a portion thereof. In an embodiment, a pixel block may be a group of one or more macroblocks. In an embodiment, a pixel block may have an equal number of rows and columns. In an embodiment a pixel block may have an unequal number of rows and columns. In an embodiment a pixel block may have an arbitrary shape including an arbitrary number of rows and an arbitrary number of columns.

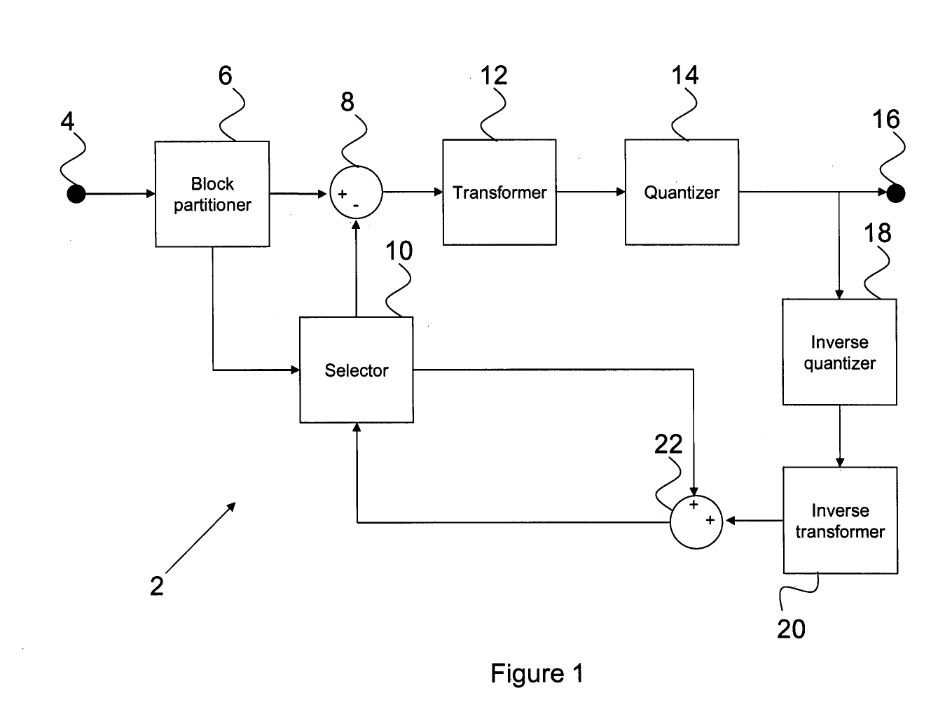

FIG. 1 illustrates an exemplary encoder 2 according to an embodiment. The encoder 2 includes an apparatus for encoding video data and is capable of performing a method of encoding video data. The encoder 2 may include an input terminal 4 configured to receive an input video signal. The input terminal 4 may be in communication with a block-partitioner 6. The block-partitioner 6 may also be in communication with a subtractor 8 and an intra prediction mode selector 10 (hereinafter referred to as the selector 10). The block-partitioner 6 may receive data from the input terminal 4 and provide data to the subtractor 8 and the selector 10. The subtractor 8 may also be in communication with the selector 10 and a transformer 12. The subtractor 8 may receive data from the block-partitioner 6 and the selector 10 and provide data to the transformer 12. The transformer 12 may also be in communication with a quantizer 14. The transformer 12 may receive data from the subtractor 8 and provide data to the quantizer 14. The quantizer 14 may also be in communication with an output terminal 16 and a return path back to the selector 10. The quantizer 14 may receive data from the transformer 12 and provide data to both the output terminal 16 and the return path.

In an embodiment, the return path may comprise an inverse quantizer 18 which may be in communication with an inverse transformer 20. The inverse transformer 20 may also be in communication with an adder 22. The adder 22 may also be in communication with the selector 10 by two paths, each path being capable of communicating data between the selector 10 and the adder 22 in a different direction. Accordingly, the inverse quantizer 18 may receive data from the quantizer 14 and provide data to the inverse transformer 20. The inverse transformer 20 may receive data from the inverse quantizer 18 and provide data to the subtractor 22. The subtractor may also receive data from the selector 10 and provide data back to the selector 10.

In an embodiment, the exemplary arrangement of FIG. 1 may operate as follows. A video input signal is received at the input terminal 4 and provided to the block-partitioner 6. At the block-partitioner 6, the video signal may be split into single-image frames and then may be sliced into pixel blocks. Such pixel blocks are also known as original pixel blocks since they are portions of the original input video signal. In an embodiment, an original pixel block may comprise a block of 4×4 pixels. In another embodiment, an original pixel block may comprise a greater or lesser number of pixels, such as, for example, 8×8 pixels or 16×16 pixels. The original pixel blocks are then passed from the block-partitioner 6 to the subtractor 8 and the selector 10. The operation of the selector will be described next.

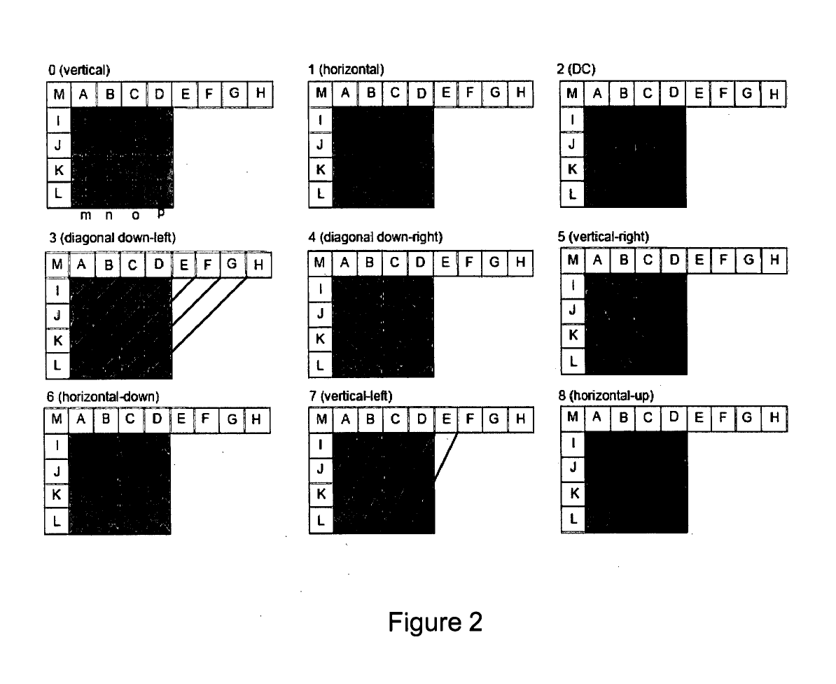

In an embodiment, at the selector 10, each original pixel block may be considered in turn. For each original pixel block, predictions of the pixel block's pixels may be generated based on neighboring pixels within the same frame of the input video signal. Such predictions are also known as predicted pixel blocks. The neighboring pixels may have been encoded previously. The pixels of each predication may be compared with the pixels of the original pixel block to identify which prediction is the best match to the original pixel block. In an embodiment, there are nine possible prediction modes (0 to 9), as seen more particularly on FIG. 2. The nine prediction modes are as follows: Mode 0—Vertical, Mode 1—Horizontal, Mode 2—DC, Mode 3—Diagonal down-left, Mode 4—Diagonal down-right, Mode 5—Vertical-right, Mode 6—Horizontal-down, Mode 7—Vertical-left, and Mode 8—Horizontal-up. It is to be understood that in some other embodiments a greater or lesser number of prediction modes may be used.

In Modes 0 and 1, a prediction is generated by predicting each pixel of an original pixel block from neighboring pixels in the vertical and horizontal direction, respectively. In Mode 2, a prediction is generated using a DC prediction involving an average of all available neighboring pixels. In Modes 3 and 4, a prediction is generated by predicting each pixel of an original pixel block from neighboring pixels from the top-right and top-left direction, respectively. In Modes 5 to 8, a prediction is generated by predicting each pixel of an original pixel block from neighboring pixels at various angles in-between Modes 0, 1, 3 and 4. In an embodiment, nine prediction modes are used to generate nine predictions of an original pixel block. As mentioned above, the pixels of each of the nine predictions may be compared to the original pixel block pixels to identify the prediction which best matches the original pixel block. In some other embodiments, a prediction other than the best matching prediction may be selected by the selector 10. In some other embodiments, only a subset of the nine predictions may be compared to the original pixel block.

In an embodiment, once a prediction mode has been selected by the selector 10, the selected prediction is provided to the subtractor 8. It is noted that the aforementioned predication process is known as intra-prediction. As mentioned previously, the subtractor 8 may also receive the original pixel block from block-partitioner 6. The subtractor 8 identifies the difference between the pixels of the selected predicted pixel block and the pixels of the original pixel block. The difference is passed from the subtractor 8 to the transformer 12. The difference is also known as a residual signal or a residual pixel block. In an embodiment, the residual pixel block may comprise one or more rows of pixels and one or more columns of pixels, for example, the residual pixel block may comprise a block of 4×4 pixels, 8×8 pixels or 16×16 pixels. At least one row and at least on column of the residual pixel block is transformed by the transformer 12 using, for example, one or more mathematical transforms, such as, for example, a discrete cosine transform (DCT). Therefore, the pixel values of the residual pixel block are converted into residual transform coefficients, also known as a coefficient block. The values of the residual transform coefficients will depend on the transform or transforms used on the rows and columns of the residual pixel block by the transformer 12.

In an embodiment, following transformation, the residual transform coefficients are provided to the quantizer 14. The quantizer 14 quantizes the residual transform coefficients to generate quantized transform coefficients. The quantized transform coefficients are then passed to the output terminal 16. In an embodiment, the output signal is encoded by the output terminal 16, for example, entropy encoded. In an embodiment, the entropy-coded changes in the quantized transform coefficients may be processed and packaged for transport over a network, for example, a wired or wireless network. It is noted that in some embodiments, output encoding, processing and packaging may be performed in the encoder 2, whereas in some other embodiments, some or all of these operations may be performed downstream of the encoder 2.

In an embodiment, the quantized transform coefficients provided to the output terminal 16 are also provided to inverse quantizer 18 and inverse transformer 20. Features 18 and 20 may perform substantially, or precisely, the inverse operations to features 12 and 14. Accordingly, the residual pixel block is output from the inverse transformer 20 to the adder 22. In an embodiment, the adder 22 also receives the selected prediction signal from the selector 10. Accordingly, the adder 22 adds together the residual pixel block and the selected predicted pixel block to arrive at the original pixel block. The original pixel block is then provided back to the selector 10 for use in prediction operations, such as, for example, subsequent prediction operations performed in respect of subsequent original pixel blocks.

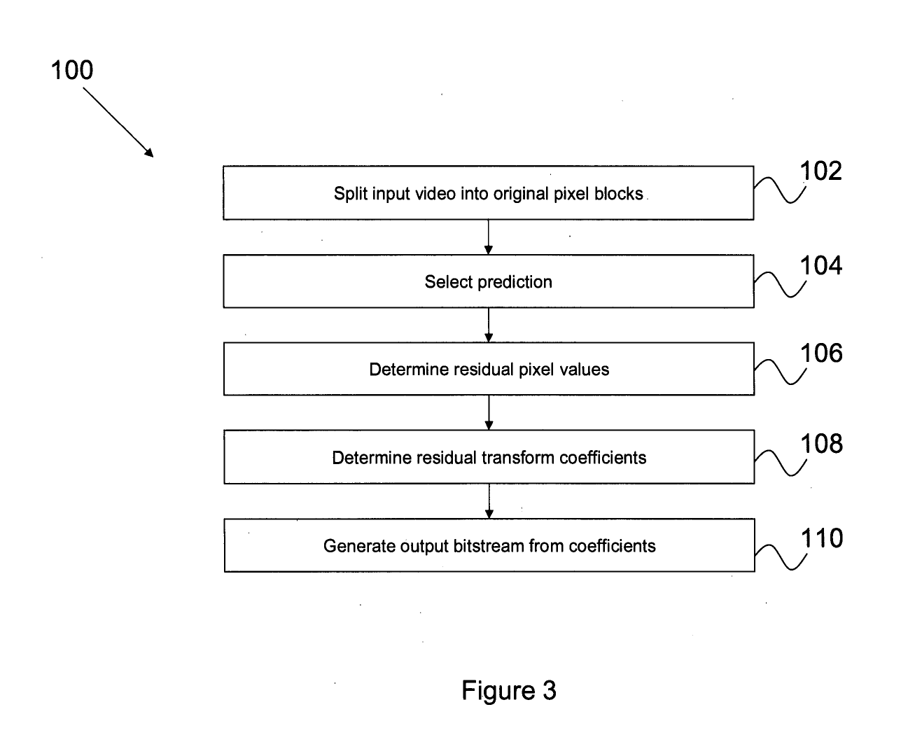

Next, the operation of an embodiment will be described with reference to flow diagram 100 of FIG. 3. At 102, an input video signal is split into original pixel blocks at the block-partitioner 6. At 104, the selector 10 receives an original pixel block, generates one or more predicted pixel blocks, and selects one of the predictions. For example, in an embodiment, nine predictions may be generated and the prediction which is the closest match to the original pixel block may be selected. At 106, the subtractor 8 generates the difference (or residual pixel block) between the selected prediction and the corresponding original pixel block. At 108, the transformer transforms at least one row and at least one column of the residual pixel block, using one or more mathematical transforms, to generate residual transform coefficients. At 110, the residual transform coefficients are quantized by quantizer 14 to generate an output bitstream at output terminal 16. In an embodiment, the output bitstream may be encoded, processed and packaged.

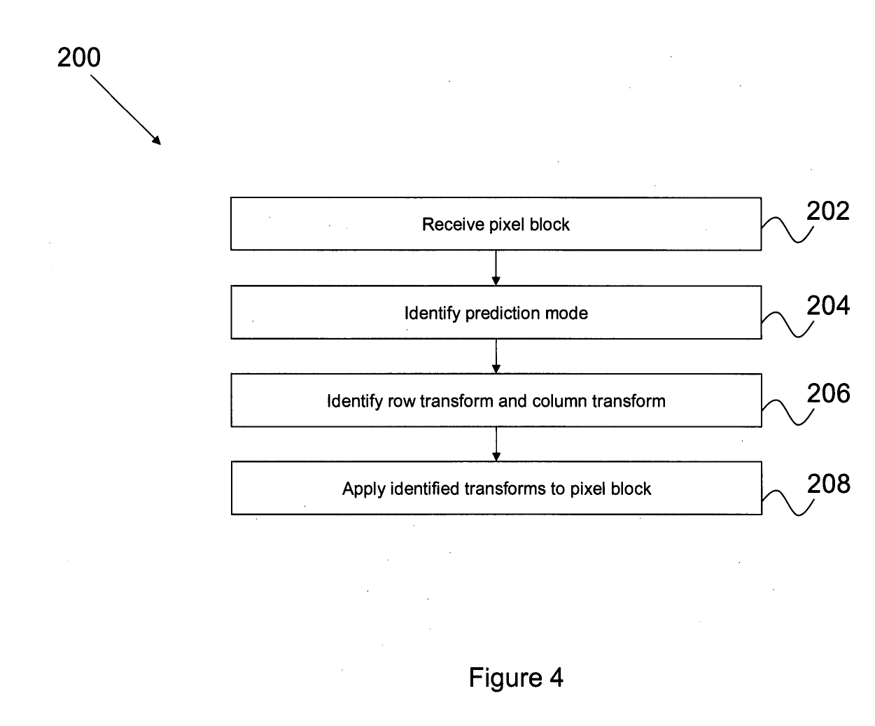

Next will be described in more detail the operation of the selector 10 and the transformer 12, with reference to an embodiment illustrated by flow diagram 200 of FIG. 4.

In an embodiment, at 202, an original pixel block is received at the selector 10. It is to be understood that the original pixel block may have originated from an input video signal and may have been split off from said input video signal, as described above. At 204, the selector 10 generates one or more predictions and selects one of the predictions. For example, nine predictions may be generated, and the closest match to the original pixel block may be selected, as described above. According to 204, the prediction mode corresponding to the selected prediction is identified, i.e. if the prediction generated by ‘Mode 0’ is selected, the ‘Mode 0’ is identified in 204. In an embodiment, the prediction mode may be identified by the selector 10 or the subtractor 8 and passed to the transformer 12. In an embodiment, the prediction mode may be identified by the transformer 12 based on the residual pixel block. In any case, at 206, the transformer 12 identifies a transform with which to transform at least one row of the residual pixel block (i.e. a row transform) and a transform with which to transform at least one column of the residual pixel block (i.e. a column transform). It is to be understood that in an embodiment, each row may be transformed by the row transform. It is also to be understood that in an embodiment, each column may be transformed by the column transform.

In an embodiment, the transformer 12 selects the row transform in dependence on the prediction mode identified in 204. In an embodiment, the transformer 12 selects the column transform in dependence on the prediction mode identified in 204. In an embodiment, the row transform and the column transform are different or the same, based on the prediction mode identified in 204. In an embodiment, the column transform and the row transform can be either one of two or more transforms. In an embodiment, the two or more transforms include a discrete cosine transform (DCT), a discrete sine transform (DST) and/or a Karhunen-Loeve transform (KLT). Once the row transform and column transform have been determined, at 208, the determined row transform and column transform are applied to the residual pixel block. Specifically, the row transform is applied to at least one row of the residual pixel block, whereas the column transform is applied to at least one column of the residual pixel block. This operation generates residual transform coefficients, which are provided to the quantizer 14, as described above.

In an embodiment, the transforms which may be selected as the row transform and/or the column transform may be stored by the encoder. In an embodiment, the transforms may be stored by a feature which is separate to the encoder but which is in communication with the encoder and therefore can provide the transforms to the encoder.

In an embodiment, one of two transforms may be selected as the row transform or the column transform. In an embodiment, the two transforms are the DCT and the KLT. In an embodiment, the DCT is an even type II discrete cosine transform. In an embodiment, the KLT is an odd type III discrete sine transform.

Below is derived one form of the KLT which may be used in some embodiments. However, before the KLT is derived, the following provides a brief description of mode-dependent directional transform (MDDT).

In an MDDT scheme, separable transforms are used. If X is an N×N block of pixels, then its 2D transform coefficients, Y, are given by:

Y=CₘXRₘ^{T}

where the subscript m in Cₘ and Rₘ denotes the dependence of the column and row transforms, respectively, on the intra prediction mode. Typically, in H.264/AVC, Cₘ=Rₘ=M, where M is the DCT. In the MDDT scheme, Cₘ and Rₘ are KLTs computed by performing singular vector decomposition (SVD) on residual blocks from each intra prediction mode collected from training video sequences.

Next is derived one form of the KLT which may be used in some embodiments. To simplify the derivation, assume that each image pixel is a random variable with zero mean and unit variance. Furthermore, assume the following image correlation model:

E[xᵢⱼxₖₗ]=ρ_{y}^{|i-k|}pₓ^{|j-l|}

where ρ_{y} and ρₓ are the correlation coefficient of neighboring pixels in the vertical and horizontal direction respectively.

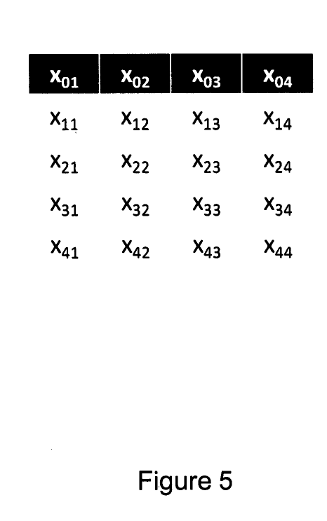

Next, an analysis is presented of the residual statistics in order to derive the KLT that should be used in conjunction with each intra prediction mode. Firstly, the statistics of the residual pixel block after intra prediction will be derived. Prediction Mode 0 will be used as an example. Prediction Mode 0 predicts in the vertical direction. In an embodiment, the residual pixel block comprises 4×4 pixels and the pixels of the residual pixel block are labeled as in FIG. 5.

Considering the statistics for each row of the residual pixel block, the covariance matrix for the kth row (1≦k≦4) is:

$$\begin{matrix}{\sum }_{ij}^{row k} = E [ {r}_{ki} {r}_{kj} ] \\ = E [ ( {x}_{ki} - {x}_{0 i} ) ( {x}_{kj} - {x}_{0 j} ) ] \\ = E [ {x}_{ki} {x}_{kj} + {x}_{0 i} {x}_{0 j} - {x}_{ki} {x}_{0 j} - {x}_{kj} {x}_{0 i} ] \\ = 2 {ρ}_{x}^{\vert i - j \vert} - 2 {ρ}_{y}^{\vert k \vert} {ρ}_{x} \vert i - j \vert \\ = 2 ( 1 - {ρ}_{y}^{\vert k \vert} ) {ρ}_{x}^{\vert i - j \vert}\end{matrix}$$

It is noted that Σᵢⱼ^{row k} is a Toeplitz matrix. Therefore, its KLT is approximately the DCT. In other words, applying a DCT on each row would be sufficient; there is no need to train a KLT specifically to handle the row-wise transform.

Considering the statistics for each column of the residual pixel block, the covariance matrix for the kth column (1≦k≦4) is:

$$\begin{matrix}{\sum }_{ij}^{col k} = E [ {r}_{ik} {r}_{jk} ] \\ = E [ ( {x}_{ik} - {x}_{0 k} ) ( {x}_{jk} - {x}_{0 k} ) ] \\ = 1 + {ρ}_{y}^{\vert i - j \vert} - {ρ}_{y}^{\vert i \vert} - {ρ}_{y}^{\vert j \vert}\end{matrix}$$

Unlike the row-wise covariance matrix, Σᵢⱼ^{col k} is not a Toeplitz matrix. Therefore, the DCT is a sub-optimal approximation. Accordingly, it is necessary to compute the KLT. However, it is possible to use the above-derived covariance matrix to compute the KLT.

The actual covariance matrix is independent of k:

$${\sum }^{col} = ( 1 - ρ ) ( \begin{matrix}2 & 1 + ρ & 1 + {ρ}^{2} & 1 + {ρ}^{3} \\ 1 + ρ & 2 ( 1 + ρ ) & {( 1 + ρ )}^{2} & ( 1 + ρ ) ( 1 + {ρ}^{2} ) \\ 1 + {ρ}^{2} & {( 1 + ρ )}^{2} & 2 ( 1 + ρ + {ρ}^{2} ) & ( 1 + ρ ) ( 1 + ρ + {ρ}^{2} ) \\ 1 + {ρ}^{3} & ( 1 + ρ ) ( 1 + {ρ}^{2} ) & ( 1 + ρ ) ( 1 + ρ + {ρ}^{2} ) & 2 ( 1 + ρ + {ρ}^{2} + {ρ}^{3} )\end{matrix} )$$

Furthermore, as ρ→1, the covariance matrix tends towards:

$${\sum }^{col} \to α ( \begin{matrix}1 & 1 & 1 & 1 \\ 1 & 2 & 2 & 2 \\ 1 & 2 & 3 & 3 \\ 1 & 2 & 3 & 4\end{matrix} )$$

where α is some constant. The inverse matrix of the above matrix can be obtained by performing a Cholesky decomposition on the above matrix, where the lower-triangular decomposition is simply all 1s. Then, performing a difference equation analysis can obtain a difference equation on the output terms. This result holds for general N. The inverse of the matrix (without the scalar multiplier) is as follows.

$$( \begin{matrix}2 & - 1 & 0 & 0 \\ - 1 & 2 & - 1 & 0 \\ 0 & - 1 & 2 & - 1 \\ 0 & 0 & - 1 & 1\end{matrix} )$$

The eigenvectors of such a tri-diagonal matrix are computed to have the following sinusoidal terms:

$${K}_{i , j} = \frac{2}{\sqrt{2 N + 1}} sin ( \frac{( 2 i - 1 ) j π}{2 N + 1} ) \qquad ( 1 )$$

where 1≦i, j≦N and the pixel block comprises N×N pixels. It is noted that the above eigenvectors are also the basis vectors of the Odd Type-3 Discrete Sine Transform.

Since Σ^{col} is a symmetric positive-definite matrix, its eigenvectors (and KLT basis) would also be the same as above.

For N=4, it is possible to obtain the following integer KLT transform:

$$K \approx \frac{1}{128} ( \begin{matrix}29 & 55 & 74 & 84 \\ 74 & 74 & 0 & - 74 \\ 84 & - 29 & - 74 & 55 \\ 55 & - 84 & 74 & - 29\end{matrix} ) \qquad ( 2 )$$

It is noted that in some embodiments, the above-derived KLT can be applied without the scale factor, i.e. without the 1/128 multiplier in the above example. Similarly, for N=8, it is possible to obtain the following integer KILT transform:

$$K \approx ( \begin{matrix}11 & 22 & 33 & 42 & 50 & 56 & 60 & 62 \\ 33 & 56 & 62 & 50 & 22 & - 11 & - 42 & - 60 \\ 50 & 60 & 22 & - 33 & - 62 & - 42 & 11 & 56 \\ 60 & 33 & - 42 & - 56 & 11 & 62 & 22 & - 50 \\ 62 & - 11 & - 60 & 22 & 56 & - 33 & - 50 & 42 \\ 56 & - 50 & - 11 & 60 & - 42 & - 22 & 62 & - 33 \\ 42 & - 62 & 50 & - 11 & - 33 & 60 & - 56 & 22 \\ 22 & - 42 & 56 & - 62 & 60 & - 50 & 33 & - 11\end{matrix} )$$

Similarly, for N=16, it is possible to obtain the following integer KLT transform:

$$K \approx ( \begin{matrix}4 & 8 & 13 & 17 & 20 & 24 & 28 & 31 & 34 & 36 & 39 & 41 & 42 & 43 & 44 & 45 \\ 13 & 51 & 34 & 41 & 44 & 44 & 41 & 34 & 24 & 13 & 0 & - 13 & - 24 & - 34 & - 41 & - 44 \\ 20 & 36 & 44 & 42 & 31 & 13 & - 8 & - 28 & - 41 & - 45 & - 39 & - 24 & - 4 & 17 & 34 & 43 \\ 28 & 43 & 41 & 20 & - 8 & - 34 & - 45 & - 36 & - 13 & 17 & 39 & 44 & 31 & 4 & - 24 & - 42 \\ 34 & 44 & 24 & - 13 & - 41 & - 41 & - 13 & 24 & 44 & 34 & 0 & - 34 & - 44 & - 24 & 13 & 41 \\ 39 & 39 & 0 & - 39 & - 39 & 0 & 39 & 39 & 0 & - 39 & - 39 & 0 & 39 & 39 & 0 & - 39 \\ 42 & 28 & - 24 & - 43 & - 4 & 41 & 31 & - 20 & - 44 & - 8 & 39 & 34 & - 17 & - 45 & - 13 & 36 \\ 44 & 13 & - 41 & - 24 & 34 & 34 & - 24 & - 41 & 13 & 44 & 0 & - 44 & - 13 & 41 & 24 & - 34 \\ 45 & - 4 & - 44 & 8 & 43 & - 13 & - 42 & 17 & 41 & - 20 & - 39 & 24 & 36 & - 28 & - 34 & 31 \\ 43 & - 20 & - 34 & 36 & 17 & - 44 & 4 & 42 & - 24 & - 31 & 39 & 13 & - 45 & 8 & 41 & - 28 \\ 41 & - 34 & - 13 & 44 & - 24 & - 24 & 44 & - 13 & - 34 & 41 & 0 & - 41 & 34 & 13 & - 44 & 24 \\ 36 & - 42 & 13 & 28 & - 45 & 24 & 17 & - 43 & 34 & 4 & - 39 & 41 & - 8 & - 31 & 44 & - 20 \\ 31 & - 45 & 34 & - 4 & - 28 & 44 & - 36 & 8 & 24 & - 43 & 39 & - 13 & - 20 & 42 & - 41 & 17 \\ 24 & - 41 & 44 & - 34 & 13 & 13 & - 34 & 44 & - 41 & 24 & 0 & - 24 & 41 & - 44 & 34 & - 13 \\ 17 & - 31 & 41 & - 45 & 42 & - 34 & 20 & - 4 & - 13 & 28 & - 39 & 44 & - 43 & 39 & - 24 & 8 \\ 8 & - 17 & 24 & - 31 & 36 & - 41 & 43 & - 45 & 44 & - 42 & 39 & - 34 & 28 & - 20 & 13 & - 4\end{matrix} )$$

In an embodiment, different scale factors may be applied to the KLT. In an embodiment, the scale factor is 128 when N=4. In an embodiment, the scale factor is 128\sqrt{2}≈181 when N=8. In an embodiment, the scale factor is 256 when N=16. In an embodiment, the scale factor is 256\sqrt{2}≈362 when N=32.

In an embodiment, using a scale factor of 128\sqrt{2}≈181, the N=8 KLT transform is:

$$K \approx ( \begin{matrix}16 & 32 & 46 & 59 & 70 & 79 & 84 & 87 \\ 46 & 79 & 87 & 70 & 32 & - 16 & - 59 & - 84 \\ 70 & 84 & 32 & - 46 & - 87 & - 59 & 16 & 79 \\ 84 & 46 & - 59 & - 79 & 16 & 87 & 32 & - 70 \\ 87 & - 16 & - 84 & 32 & 79 & - 46 & - 70 & 59 \\ 79 & - 70 & - 16 & 84 & - 59 & - 32 & 87 & - 46 \\ 59 & - 87 & 70 & - 16 & - 46 & 84 & - 79 & 32 \\ 32 & - 59 & 79 & - 87 & 84 & - 70 & 46 & - 16\end{matrix} )$$

In an embodiment, using a scale factor of 256, the N=16 KLT transform is:

$$K \approx ( \begin{matrix}8 & 17 & 25 & 33 & 41 & 48 & 55 & 62 & 67 & 73 & 77 & 81 & 84 & 87 & 88 & 89 \\ 25 & 48 & 67 & 81 & 88 & 88 & 81 & 67 & 48 & 25 & 0 & - 25 & - 48 & - 67 & - 81 & - 88 \\ 41 & 73 & 88 & 84 & 62 & 25 & - 17 & - 55 & - 81 & - 89 & - 77 & - 48 & - 8 & 33 & 67 & 87 \\ 55 & 87 & 81 & 41 & - 17 & - 67 & - 89 & - 73 & - 25 & 33 & 77 & 88 & 62 & 8 & - 48 & - 84 \\ 67 & 88 & 48 & - 25 & - 81 & - 81 & - 25 & 48 & 88 & 67 & 0 & - 67 & - 88 & - 48 & 25 & 81 \\ 77 & 77 & 0 & - 77 & - 77 & 01 & 77 & 77 & 0 & - 77 & - 77 & 0 & 77 & 77 & 0 & - 77 \\ 84 & 55 & - 48 & - 84 & - 8 & - 81 & 62 & - 41 & - 88 & - 17 & 77 & 67 & - 33 & - 89 & - 25 & 73 \\ 88 & 25 & - 81 & - 48 & 67 & 67 & - 48 & - 81 & 25 & 88 & 0 & - 88 & - 25 & 81 & 48 & - 67 \\ 89 & - 8 & - 88 & 17 & 87 & - 25 & - 84 & 33 & 81 & - 41 & - 77 & 48 & 73 & - 55 & - 67 & 62 \\ 87 & - 41 & - 67 & 73 & 33 & - 88 & 8 & 84 & - 48 & - 62 & 77 & 25 & - 89 & 17 & 81 & - 55 \\ 81 & - 67 & - 25 & 88 & - 48 & - 48 & 88 & - 25 & - 67 & 81 & 0 & - 81 & 67 & 25 & - 88 & 48 \\ 73 & - 84 & 25 & 55 & - 89 & 48 & 33 & - 87 & 67 & 8 & - 77 & 81 & - 17 & - 62 & 88 & - 41 \\ 62 & - 89 & 67 & - 8 & - 55 & 88 & - 73 & 17 & 48 & - 87 & 77 & - 25 & - 41 & 84 & - 81 & 33 \\ 48 & - 81 & 88 & - 67 & 25 & 25 & - 67 & 88 & - 81 & 48 & 0 & - 48 & 81 & - 88 & 67 & - 25 \\ 33 & - 62 & 81 & - 89 & 84 & - 67 & 41 & - 8 & - 25 & 55 & - 77 & 88 & - 87 & 73 & - 48 & 17 \\ 17 & - 33 & 48 & - 62 & 73 & - 81 & 87 & - 89 & 88 & - 84 & 77 & - 67 & 55 & - 41 & 25 & - 8\end{matrix} )$$

For comparison, for N=4, an integer DCT transform matrix is as follows:

$$M \approx \frac{1}{128} ( \begin{matrix}64 & 64 & 64 & 64 \\ 84 & 35 & - 35 & - 84 \\ 64 & - 64 & - 64 & 64 \\ 35 & - 84 & 84 & - 35\end{matrix} )$$

In summary, for the vertical prediction mode (Mode 0), the DCT transform should be applied to the rows of the residual pixel block, since the DCT provides a suitable approximation. Additionally, the above-derived KLT transform should be applied to the columns of the residual pixel block, since the DCT provides a sub-optimal approximation.

The analysis for horizontal prediction (Mode 1) is very similar to the above analysis for Mode 0. Accordingly, the above-derived KLT transform should be applied to the rows of the residual pixel block. Additionally, the DCT transform should be applied to the columns of the residual pixel block.

For DC prediction (Mode 2), a single DC value is used as the predictor for all pixels. Suppose that the predictor is equally correlated to all the pixels in the source. Then, the resulting covariance matrix is Toeplitz for both column and row. Therefore, the DCT is a sufficient approximation for both the rows and columns of the residual pixel block.

It is possible to do a similar analysis for Modes 3, 7 and 8. It turns out that a combination of DCT and the above-derived KLT is also prescribed for these modes. For modes 4, 5 and 6, the analysis is not so straightforward since neighboring pixels along both horizontal and vertical edges are used for prediction. However, a comparison between the above-derived KLT matrix and corresponding trained matrices used in the MDDT scheme reveals that the two are in fact very similar. Therefore, the above-derived KLT provides a sufficient approximation for both the rows and columns of the residual pixel block in these three modes.

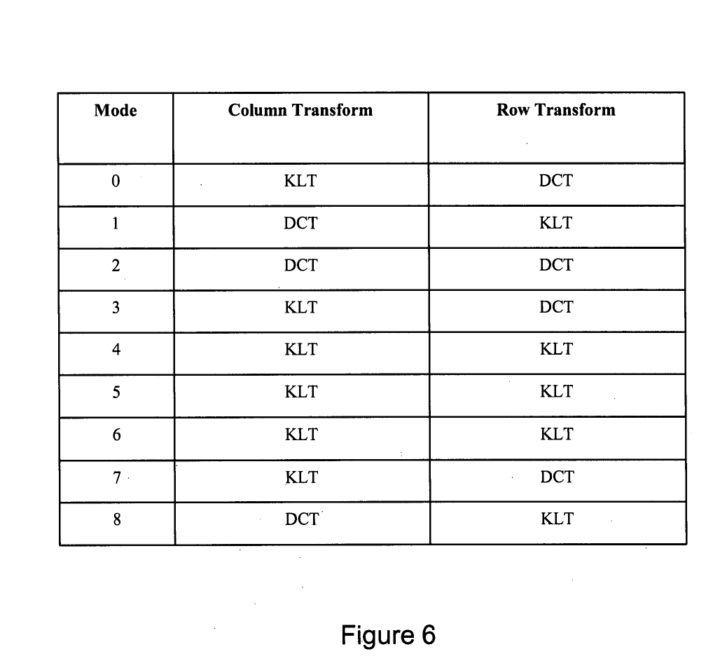

FIG. 6 summarizes the above. In particular, the table of FIG. 6 shows, for each prediction mode, which transform (DCT or KLT) is selected to be the row transform and which transform (DCT or KLT) is selected to be the column transform.

Next will be described how the above-derived KLT is applied to the pixels of a residual pixel block.

The above-described 4×4 DCT matrix and 4×4 KLT matrix are already integer transforms with 8-bit precision. The integer DCT can be performed with a fast transform requiring only 4 multiplication operations and 8 addition operations per 1-D transform operation. It is noted that ‘1-D’ refers to each row or column transform.

In general, there is no fast transform for applying a KLT. One possible reason for this is that even when N is a power of 2, the implicit periodic extension is 4N+1, which is not a power of 2. Since there is no fast transform, it is generally necessary to perform a full matrix multiplication in order to apply a KLT to a residual pixel block. For N=4, a full matrix multiplication would require 16 multiplication operations and 12 addition operations per 1-D transform operation.

However, the above-derived KLT for N=4 has a structure that can be exploited to reduce the total number of operations which need to be performed to apply the KLT to a residual pixel block when compared to a full matrix multiplication. The following illustrates an exemplary KLT transform operation applied to an exemplary row or column (x₁, x₂, x₃, x₄) of a residual pixel block, to generate a corresponding coefficient block (y₁, y₂, y₃, y₄).

$$( \begin{matrix}{y}_{1} \\ {y}_{2} \\ {y}_{3} \\ {y}_{4}\end{matrix} ) = {[ \frac{2}{\sqrt{2 N + 1}} sin ( \frac{( 2 i + 1 ) j π}{2 N + 1} ) ]}_{i , j}^{4} ( \begin{matrix}{x}_{1} \\ {x}_{2} \\ {x}_{3} \\ {x}_{4}\end{matrix} )$$

where the notation [f_{N}(i,j)]_{i,j}^{N} is used to denote a N×N matrix with the (i,j) entry being given by f_{N}(i, j). It is therefore possible to identify that:

$${[ \frac{2}{\sqrt{2 N + 1}} sin ( \frac{( 2 i + 1 ) j π}{2 N + 1} ) ]}_{i , j}^{4} = \frac{2}{\sqrt{2 N + 1}} ( \begin{matrix}{s}_{9}^{1} & {s}_{9}^{2} & {s}_{9}^{3} & {s}_{9}^{4} \\ {s}_{9}^{3} & {s}_{9}^{3} & 0 & - {s}_{9}^{3} \\ {s}_{9}^{4} & - {s}_{9}^{1} & - {s}_{9}^{3} & {s}_{9}^{2} \\ {s}_{9}^{2} & - {s}_{9}^{4} & {s}_{9}^{3} & - {s}_{9}^{1}\end{matrix} )$$

$$where {s}_{k}^{l} = sin ( \frac{l π}{k} ) .$$

Ignoring the scale factor, the forward 4-point KLT, and the application of the KLT transform, can be expressed as follows:

$$( \begin{matrix}{y}_{0} \\ {y}_{1} \\ {y}_{2} \\ {y}_{3}\end{matrix} ) = ( \begin{matrix}29 & 55 & 74 & 84 \\ 74 & 74 & 0 & - 74 \\ 84 & - 29 & - 74 & 55 \\ 55 & - 84 & 74 & - 29\end{matrix} ) ( \begin{matrix}{x}_{0} \\ {x}_{1} \\ {x}_{2} \\ {x}_{3}\end{matrix} )$$

The above transformation can be performed by the following sequence of operations:

c₀=x₀+x₃

c₁=x₁+x₃

c₂=74x₂

y₀=29c₀+55c₁+c₂

y₁=74(x₀+x₁−x₃)

y₂=84c₀−29c₁−c₂

y₃=55c₀−84c₁+c₂

The above sequence of operations requires only 8 multiplication operations and 10 addition operations. It is noted that the number of multiplications and additions required to perform the above sequence of operations is fewer than number of multiplications and additions required to perform full matrix multiplication.

Alternatively, the above transform can be performed by the following sequence of operations:

c₀=29x₀+84x₃

c₁=74x₂

c₂=55x₀−29x₃

y₀=c₀+55x₁+c₂

y₁=74(x₀+x₁−x₃)

y₂=c₀−29x₁−c₂+c₃

y₃=−84x₁+c₂+c₃

The above sequence of operations requires only 9 multiplication operations and 11 addition operations. In fact, this not only holds for this particular integer KLT transform, but holds in general for original transform in equation (1) above. It is noted that the number of multiplications and additions required to perform the above sequence of operations is fewer than number of multiplications and additions required to perform full matrix multiplication.

Alternatively, the above transform can be performed by the following sequence of operations:

a0=x0+x3

a1=x1+x3

a2=74*x2

a3=x0+x1−x3

b0=29*a0+55*a1

b1=84*a0−29*a1

y0=b0+a2

y1=74*a3

y2=b1−a2

y3=b1−b0+a2

The above sequence of operations requires only 6 multiplication operations and 10 addition operations. Alternatively, the above transform can be performed by the following sequence of operations:

a0=x0+x3

a1=x1+x3

a2=74*x2

a3=x0+x1−x3

a4=x0−x1

b0=28*(a0+a1<<1)+a4

b1=28*(a0<<1+a4)−a1

y0=b0+a2

y1=74*a3

y2=b1−a2

y3=b1−b0+a2

The above sequence of operations requires only 4 multiplication operations, 13 addition operations and 2 bitshift operations.

An approximation of the forward 4-point KLT can be expressed as follows:

$$( \begin{matrix}{y}_{0} \\ {y}_{1} \\ {y}_{2} \\ {y}_{3}\end{matrix} ) = ( \begin{matrix}28 & 56 & 74 & 84 \\ 74 & 74 & 0 & - 74 \\ 84 & - 28 & - 74 & 56 \\ 56 & - 84 & 74 & - 28\end{matrix} ) ( \begin{matrix}{x}_{0} \\ {x}_{1} \\ {x}_{2} \\ {x}_{3}\end{matrix} )$$

The above transformation can be performed by the following sequence of operations:

a0=x0+x3

a1=x1+x3

a2=74*x2

a3=x0+x1−x3

b0=28*(a0+a1<<1)

b1=84*a0−28*a1

y0=b0+a2

y1=74*a3

y2=b1−a2

y3=b1−b0+a2

The above sequence of operations requires only 5 multiplication operations, 10 addition operations and 1 bitshift operations. Alternatively, the above transform can be performed by the following sequence of operations:

a0=x0+x3

a1=x1+x3

a2=74*x2

a3=x0+x1−x3

b0=28*(a0+a1<<1)

b1=28*(a0<<1+a0−a1)

y0=b0+a2

y1=74*a3

y2=b1−a2

y3=b1−b0+a2

The above sequence of operations requires only 4 multiplication operations, 11 addition operations and 2 bitshift operations.

Additionally, the inverse transformation operation can expressed as follows:

$$( \begin{matrix}{x}_{0} \\ {x}_{1} \\ {x}_{2} \\ {x}_{3}\end{matrix} ) = ( \begin{matrix}29 & 74 & 84 & 55 \\ 55 & 74 & - 29 & - 84 \\ 74 & 0 & - 74 & 74 \\ 84 & - 74 & 55 & - 29\end{matrix} ) ( \begin{matrix}{y}_{0} \\ {y}_{1} \\ {y}_{2} \\ {y}_{3}\end{matrix} )$$

The above transformation can be performed by the following sequence of operations:

b₀=y₀+y₂

b₁=74y₁

b₂=y₂+y₃

x₀=29b₀+b₁+55b₂

x₁=55b₀+b₁−84b₂

x₂=74(y₀−y₂+y₃)

x₃=84b₀−b₁−29b₂

As before, the above sequence of operations requires only 8 multiplication operations and 10 addition operations.

Alternatively, the inverse transform can be computed by the following sequence of operations:

b₀=29y₀+55y₃

b₁=74y₁

b₂=84y₀+29y₃

x₀=b₀+b₁+84y₂

x₁=b₃−b₀+b₁−29y₂

x₂=74(y₀−y₂+y₃)

x₃=b₃−b₁+55y₂

As before, the above sequence of operations requires only 9 multiplication operations and 11 addition operations.

Alternatively, the above transform can be performed by the following sequence of operations:

a0=y0−y3

a1=y2+y3

a2=y0−y2+y3

a3=74*y1

b0=29*a0+84*a1

b1=55*a0−29*a1

x0=b0+a3

x1=b1+a3

x2=74*a2

x3=b0+b1−a3

The above sequence of operations requires only 6 multiplication operations and 10 addition operations. Alternatively, the above transform can be performed by the following sequence of operations:

a0=y0−y3

a1=y2+y3

a2=y0−y2+y3

a3=74*y1

a4=y0+y2

b0=28*(a1<<1+a4)+a0

b1=28*(a0<<1−a1)−a4

x0=b0+a3

x1=b1+a3

x2=74*a2

x3=b0+b1−a3

The above sequence of operations requires only 4 multiplication operations, 13 addition operations and 2 bitshift operations.

An approximation of the inverse transform can be expressed as follows:

$$( \begin{matrix}{x}_{0} \\ {x}_{1} \\ {x}_{2} \\ {x}_{3}\end{matrix} ) = ( \begin{matrix}28 & 74 & 84 & 56 \\ 56 & 74 & - 28 & - 84 \\ 74 & 0 & - 74 & 74 \\ 84 & - 74 & 56 & - 28\end{matrix} ) ( \begin{matrix}{y}_{0} \\ {y}_{1} \\ {y}_{2} \\ {y}_{3}\end{matrix} )$$

The above transformation can be performed by the following sequence of operations:

a0=y0−y3

a1=y2+y3

a2=y0−y2+y3

a3=74*y1

b0=28*a0+84*a1

b1=28*(a0<<1−*a1)

x0=b0+a3

x1=b1+a3

x2=74*a2

x3=b0+b1−a3

The above sequence of operations requires only 5 multiplication operations, 10 addition operations and 1 bitshift operations. Alternatively, the above transform can be performed by the following sequence of operations:

a0=y0−y3

a1=y2+y3

a2=y0−y2+y3

a3=74*y1

b0=28*(a0+a1<<1+a1)

b1=28*(a0<<1−a1)

x0=b0+a3

x1=b1+a3

x2=74*a2

x3=b0+b1−a3

The above sequence of operations requires only 4 multiplication operations, 11 addition operations and 2 bitshift operations.

Next are presented experimental results relating to a first example implementation of the above described operation. In the experiments, the performance of the above-derived KLT was examined. The first example implementation was performed on the JM-KTA software platform (JM11.0KTA2.6r1). It is also possible to use equation (1) above for 8×8 residual pixel blocks in order to find the KTL matrix to be used.

In the first example implementation, transformations were performed on residual pixel blocks of the following sizes: 4×4, 8×8 and 16×16. Further, transformations were performed on the basis of each of the nine prediction modes illustrated in FIG. 2, and according to the combinations summarized in FIG. 6. It is noted that for the residual pixel block of size 16×16, only the vertical and horizontal prediction modes (Mode 0 and Mode 1) are applicable.

In the first example implementation, the following KTA tools were used in both all-intra and hierarchical-B configurations: adaptive loop filter (UseAdaptiveLoopFilter=1), extended block sizes (UseExtMB=2) and RDOQ (UseRDO_Q=1). Additionally, the hierarchical-B configurations used motion vector competition (MVCompetition=1) and new offset for weighted prediction (UseNewOffset=1).

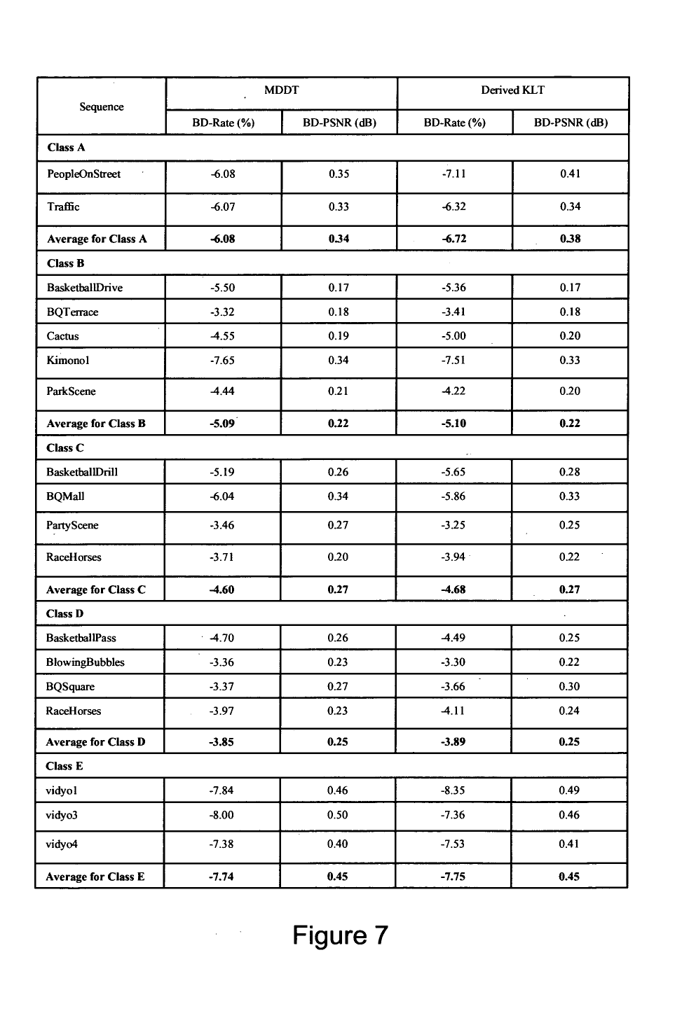

In the experimental results relating to the first example implementations, an exemplary MDDT is compared to the above-described technique with KTA and without MDDT (but with the other KTA tools enabled). FIG. 7 shows the RD (rate-distortion) results when all the frames are coded as intra, for all the test sequences used in the HVC CfP (high-performance video coding call for proposals). It can be seen that the proposed technique matches the RD performance of MDDT, but requires less storage and computational complexity.

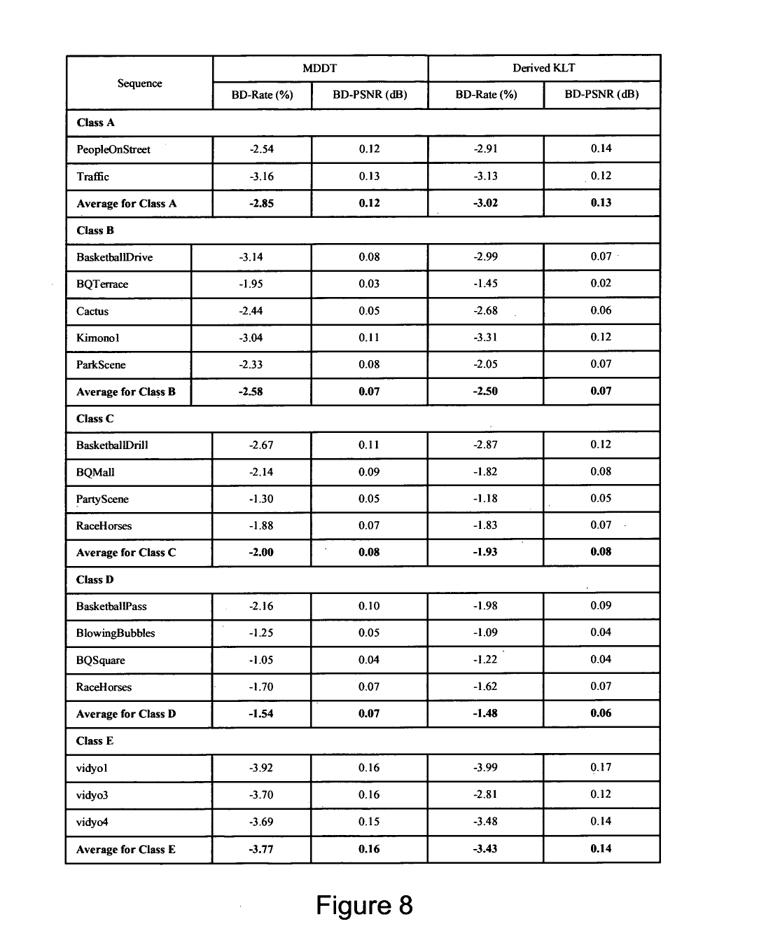

FIG. 8 shows the RD results when the hierarchical-B configuration is used, as in the alpha anchor in the HVC CfP. In this configuration, a IbBbBbBbP coding structure is used, with an IDR (instantaneous decoding refresh) period of at most 1.1 seconds (as in the HVC CfP).

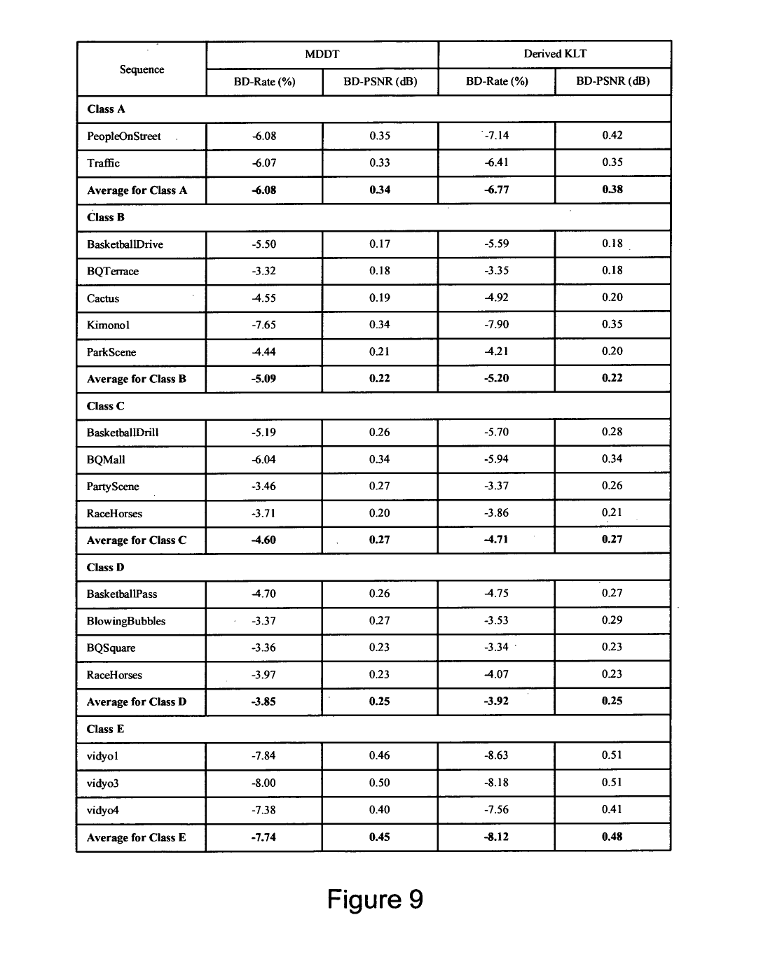

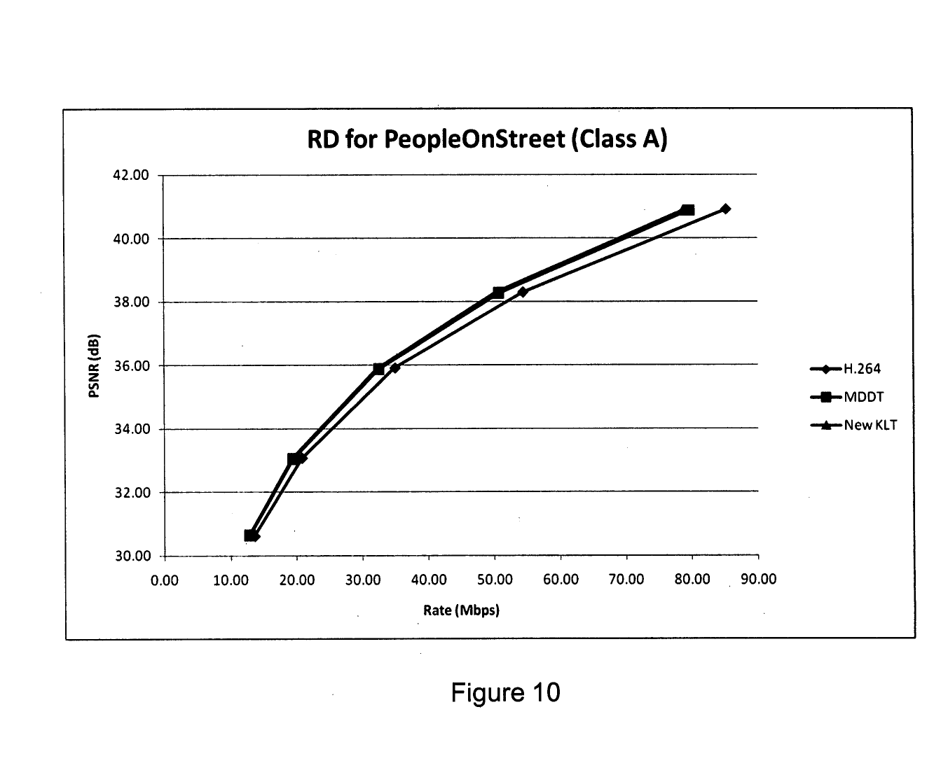

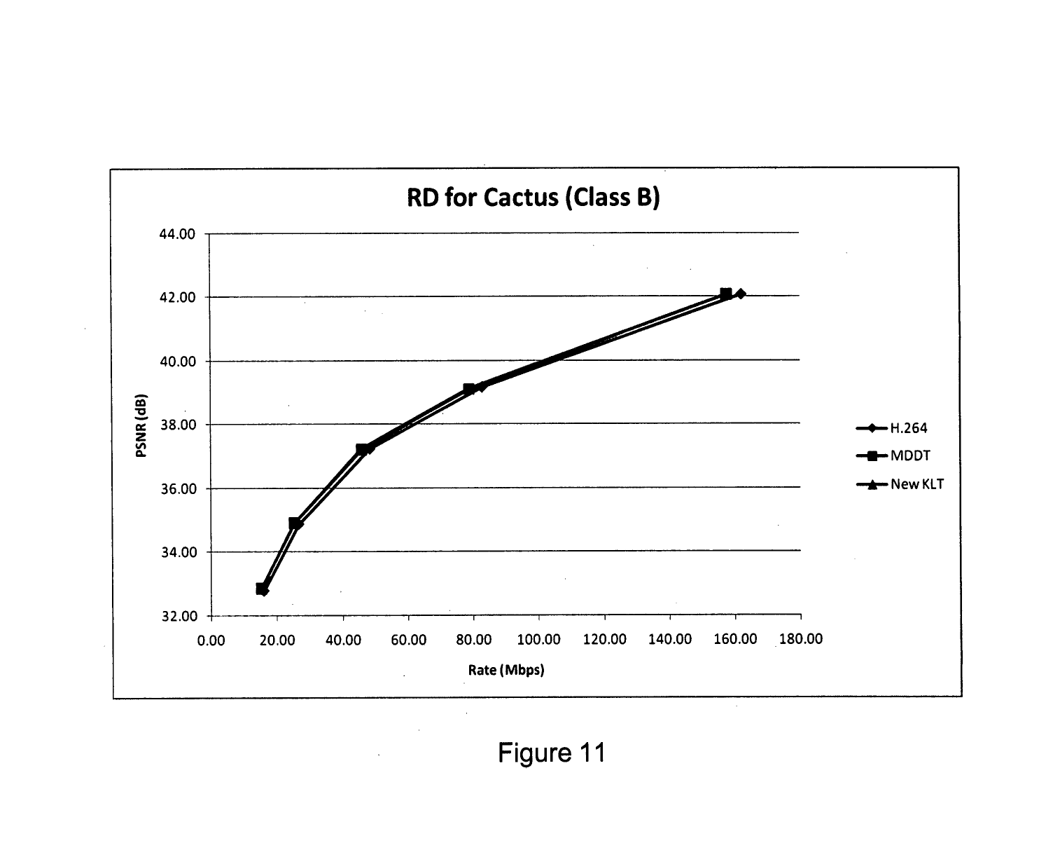

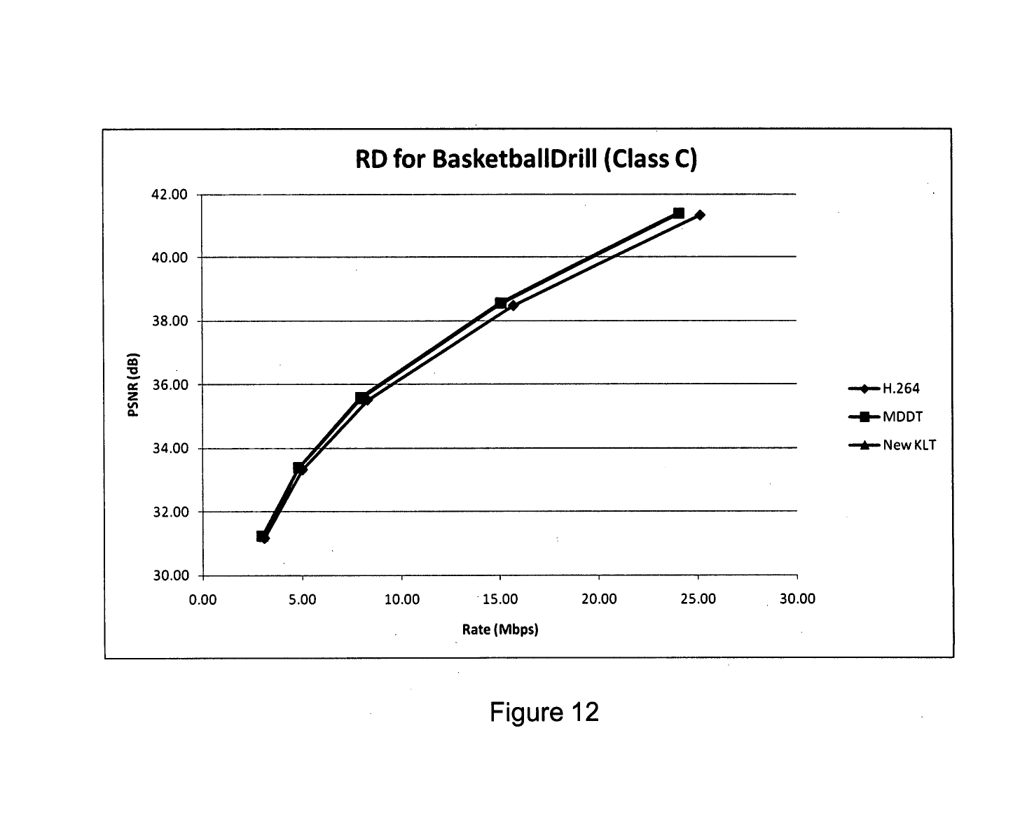

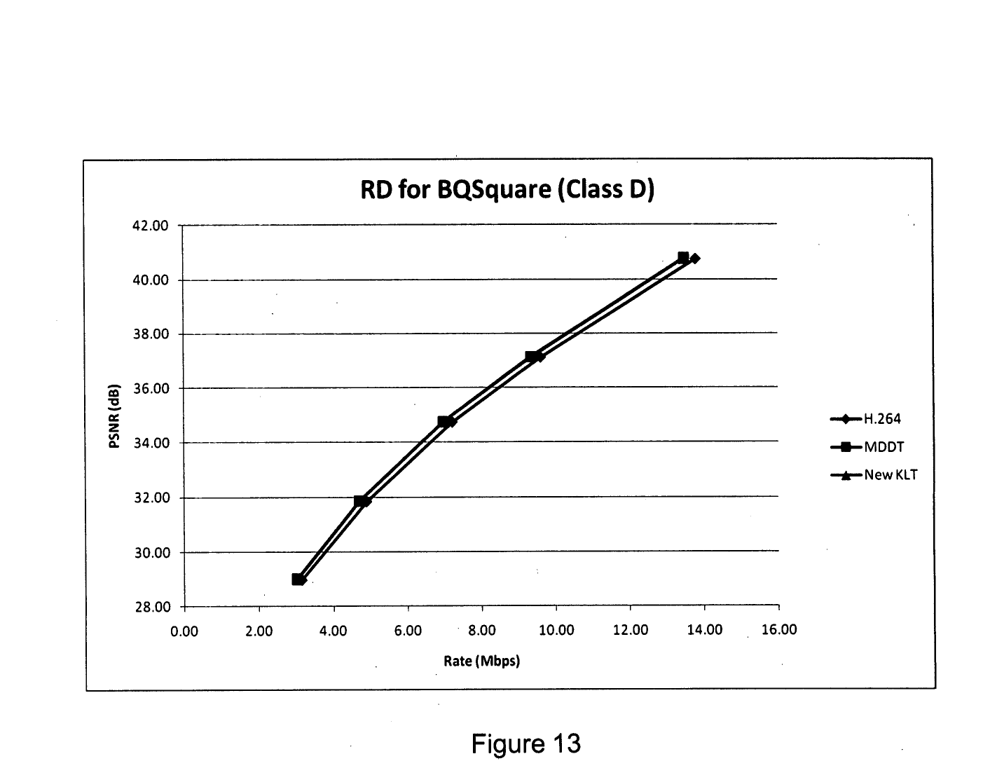

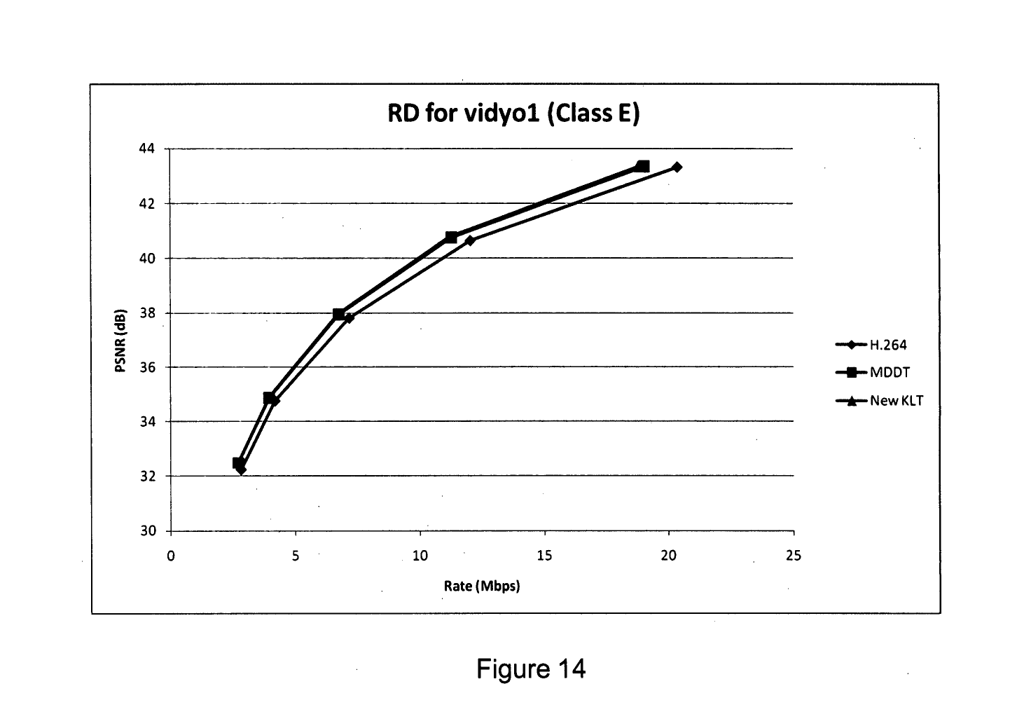

In a second example implementation, most of the common conditions were used, including CABAC (context-adaptive binary arithmetic coding) and use of 8×8 transform. New coding features of the KTA, such as, adaptive in-loop filter and adaptive quantization matrix selection were used to ensure that the above-combinations of transforms were compatible with other advanced video coding tools. The MPEG HVC test sequences were used, and all frames were intra encoded. In the experimental results shown in FIG. 9, typical MDDT and the above-described scheme are both compared with H.264/AVC. FIGS. 10 to 14 illustrate RD curves for a representative video from each class of the MPEG HVC test sequences.

From the experimentation results, it can be seen that the above-described embodiment has a very similar performance to MDDT. In fact, for each class of test sequences, the above-described method has an average performance that is slightly better than MDDT. Therefore, without any training, the above-described embodiment at least matches the performance of MDDT, and this can be done with lower computational and storage costs.

It is an advantage of the above-described embodiment that separable KLTs are derived which are suitable for coding H.264/AVC intra prediction residuals, using a simple image correlation model. The above analysis shows that for some intra prediction modes, the DCT is used for performing either the row-wise or column-wise transform. Furthermore, the KLT to be used based on the image correlation model has been derived, and comprises sinusoidal terms. The 4×4 transform also has a structure that can be exploited to reduce the operation count of the transform operation. In the above-described embodiments, only two matrices are used: the DCT and the above-derived KLT. The experimental results show that in terms of coding efficiency, the above-described embodiment out-performs MDDT most of the time. More importantly, compared to MDDT, the above-described embodiment requires no training and has lower computational and storage costs. Accordingly, the above-described embodiment is suitable for adoption in the TM/TMuC (test model/test model under consideration) and for Core Experiments.

It is an advantage of the above-described embodiment that it is necessary to use only two transform matrices for each residual pixel block size (one of which is the DCT). Accordingly, if the transforms are stored, storage capacity of only two transforms is necessary. This is a significant saving compared to MDDT, wherein 18 transform matrices must be stored for each block size.

It is an advantage of the above-described embodiment that a fast method of computing the above-derived KLT matrix is provided. Therefore, transforming the residual pixel block into a coefficient block can be performed quickly, particularly when compared to MDDT. Accordingly, the above-described embodiment can perform video coding quickly, particularly when compared to MDDT.

It is an advantage of the above-described embodiment that a statistical analysis is performed of intra prediction residual pixel blocks for various prediction modes in order to determine why directional transforms would provide more coding gain than DCT. From this insight, a set of transforms has been derived without training. Furthermore, the performance of the above-described embodiments matches the performance of MDDT (which requires training) while requiring less computational complexity and storage.

An advantage of the above-described embodiment is that it provides significant computational savings compared to MDDT. Specifically, in Modes 0, 1, 3, 7 and 8 the above-described embodiment provides a 59% reduction in complexity. In Mode 2, the above-described embodiment provides a 75% reduction in complexity. In Modes 4, 5 and 6, the above-described embodiment provides a 44% reduction in complexity.

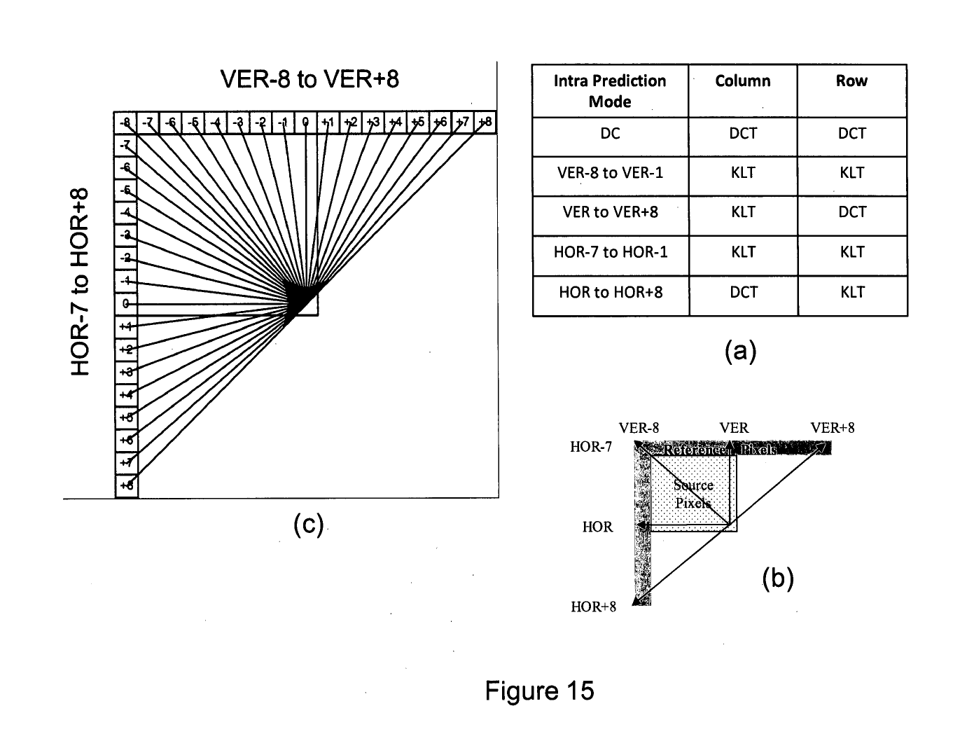

In the above-described embodiment, nine prediction modes are considered. The combination of transforms to be used on rows and columns of the residual pixel block depends on the intra prediction mode of the residual pixel block. FIG. 15a illustrates another possible choice of transforms for an embodiment. In FIG. 15b, the prediction modes shown are: “DC”—DC prediction, “VER+x”—vertical prediction with an offset of x, and “HOR+x”—horizontal prediction with an offset of x. Specifically, in each mode the source pixels are predicted using particular reference pixels. The particular reference pixels used in each prediction mode are indicated by the name of the prediction mode. For example, in the VER-8 to VER-1 mode, the reference pixels used are those located on the reference pixel scale from the location of the VER-8 scale marker to where the VER-1 scale marker would be, i.e. just to the left of the VER scale marker. For example, in the HOR-7 to HOR-1 mode, the reference pixels used are those located on the reference pixel scale from the location of the HOR-7 scale marker to where the HOR-1 scale marker would be, i.e. just below the HOR scale marker. It is noted that, as before, in the DC mode an average of all reference pixels is used for the prediction. FIG. 15c illustrates in more detail how to identify which reference pixels are used for each prediction mode.

It can be seen from FIG. 15a that, for the DC mode, the DCT is used as both the column and row transform. For the VER-8 to VER-1 mode and the HOR-7 to HOR-1 mode, the KLT is used as both the column and mw transform. For the VER to VER+8 mode, the KLT is used as the column transform and the DCT is used as the row transform. For the HOR to HOR+8 mode, the DCT is used as the column transform and the KLT is used as the row transform.

In a conventional MDDT implementation, fixed-point arithmetic (with 7 bits of fractional accuracy) is used to implement the KLT transform. This means that the actual implemented integer KLT transform is not exactly orthogonal. When the transform is not exactly orthogonal, distortion can be introduced after performing the forward KLT transform (e.g. in a transformer) followed by the backward transform (e.g. in an inverse transformer) even without any quantization of the transform coefficients. It is noted that the above-described encoder 2 of FIG. 1 included transformer 12 and inverse transformer 20.

In an embodiment, an integer approximation of the 4-point (i.e. N=4) KLT that is exactly orthogonal is presented. Consider the following matrix:

$${\hat{K}}^{4} = round ( 11.5 \times {[ \frac{2}{\sqrt{2 N + 1}} sin ( \frac{( 2 i + 1 ) j π}{2 N + 1} ) ]}_{i , j}^{4} ) = ( \begin{matrix}3 & 5 & 7 & 8 \\ 7 & 7 & 0 & - 7 \\ 8 & - 3 & - 7 & 5 \\ 5 & - 8 & 7 & - 3\end{matrix} ) \qquad ( 3 )$$

In the above expression, a scale factor of 11.5 is introduced. In an embodiment, any scale factor in the range of [11.43, 12.83] could be used to produce the same transform matrix. In an embodiment, the scale factor may be any arbitrary numerical value. In an embodiment, the scale factor is 128 when N=4. In an embodiment, the scale factor is 128\sqrt{2}≈181 when N=8. In an embodiment, the scale factor is 256 when N=16. In an embodiment, the scale factor is 256\sqrt{2}≈362 when N=32. It is noted that \hat{K}⁴ is orthogonal. Furthermore, each transform coefficient is at most the sum of two powers of 2. Therefore, the transform can be efficiently implemented with just bit-shifts and additions, as shown in the following sequence of operations:

c₁=x₁+X₄

c₂=x₂+x₄

c₃=(x₃<<3)−x₃

c₄=x₁+x₂−x₄

d₁=(c₁=<2)

d₂=(c₂<<2)+c₃

y₁=d₁−c₁+d₂+c₂

y₂=(c₄<<3)−c₄

y₃=(c₁<<3)−d₂+c₂

y₄=d₁+c₁−(c₂<<3)+c₃

In the above sequence of operations, bit-shift operations are denoted by “<<”. A total of 6 bit-shifters and 15 adders are needed to compute the forward transform.

The backward transform is simply \hat{K}^{4T}. The following sequence of operations performs the backward transform:

b₁=y₁+y₃

b₂=(y₂<<3)−y₂

b₃=y₃+y₄

b₄=y₁−y₃+y₄

e₁=(b₁<<2)

e₂=(b₃<<2)+b₂

x₁=e₁b₁+e₃+b₃

x₂=e₁+b₁+b₂−(b₃<<3)

x₃=(b₄<<3)−b₄

x₄=(b₁<<3)−e₃+b₃

An advantage of the above implementation is that it only increases the input dynamic range by about 5 bits.

In practice, the transform and quantization are typically performed to handle the scaling that is introduced in each of the forward and backward transform operations. Further details regarding the quantization scaling matrices used are provided below in Appendix I.

In an embodiment, an alternative scaling is used that results in an integer approximation of the KLT that is orthogonal. Consider the following matrix:

$${\tilde{K}}^{4} = round ( 2 \times {[ \frac{2}{\sqrt{2 N + 1}} sin ( \frac{( 2 i + 1 ) j π}{2 N + 1} ) ]}_{i , j}^{4} ) = ( \begin{matrix}0 & 1 & 1 & 1 \\ 1 & 1 & 0 & - 1 \\ 1 & 0 & - 1 & 1 \\ 1 & - 1 & 1 & 0\end{matrix} ) \qquad ( 4 )$$

In the above expression, a scale factor of 2 is used. In an embodiment, any scale factor in the range of [1.17, 2.19] could be used to produce the same transform matrix. In an embodiment, the scale factor may be any arbitrary numerical value. In an embodiment, the scale factor is 128 when N=4. In an embodiment, the scale factor is 128\sqrt{2}≈181 when N=8. In an embodiment, the scale factor is 256 when N=16. In an embodiment, the scale factor is 256\sqrt{2}≈362 when N=32. It is noted that \tilde{K}⁴ is also orthogonal. A straightforward implementation of this transform would require only 8 additions, without any multiplications or bit-shifts, since all the matrix entries are either 1 or −1.

Experiments were performed using the above-derived KLT (4). Each 4-point KLT was implemented in the current HEVC (high efficiency video coding) Test Model 1 (HM1) reference software, TMuC (test model under consideration) v0.9. Since the combination of transforms used is mode-dependent, there was no need to add any bitstream syntax.

In the experiments, an all intra coding configuration was used, with CABAC as the entropy coder in the high-efficiency setting. All the HEVC test sequences were used, and coding was done at 4 QP (quantization parameter) values (22, 27, 32, 37) for each sequence and method. The coding performance of HM1 with and without the proposed simplified MDDT transforms is compared. For comparison, the coding performance of above-described KLT (2) and a well known MDDT scheme with the trained KLTs were also measured against the KLT (4). Coding performance is measured using BD-Rate.

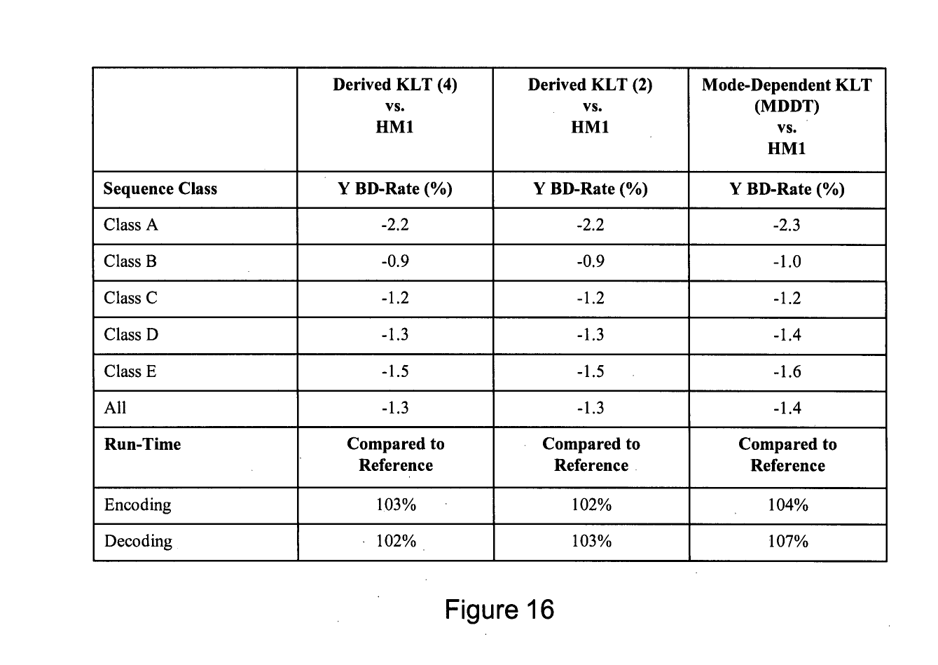

FIG. 16 summarizes the performance of the subject schemes compared to the HM1 reference. The results show that KLT (4) is able to match the performance of both the KLT (2) and a well-known mode-dependent trained KLTs.

According to the above-described embodiment, a method has been proposed for implementing an integer KLT (odd type-3 discrete sine transform) that is exactly orthogonal and can be implemented using only bit-shifters and adders without any multipliers. Furthermore, the transform only increases the dynamic range by about 5 bits. Accordingly, the above-described implementation is suitable for a low-complexity architecture. Furthermore, experimental results show that the above-described implementation matches the coding performance of the above-described KLT (2), and also fixed-point arithmetic implementation of trained KLTs used in MDDT.

It is an advantage of the above-described embodiment that a method for performing a multiplier-free 4-point integer KLT (discrete sine transform) is presented. An integer approximation of the KLT that is exactly orthogonal is presented. Furthermore, the resulting integer KLT can be implemented without any multiplications. Experimental results show that the integer KLT has compression performance that is similar to the higher precision fixed-point arithmetic implementation.

It is an advantage of the above-described embodiments that intra-coding rate is reduced. This is particularly advantageous since even though a typical compressed video may contain only a small fraction of intra-frames, because of their lower compression efficiency compared to inter-frames, intra-frames still take up a significant chunk of the overall rate.

While the invention has been particularly shown and described with reference to specific example embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

It is noted that the methods and apparatuses of the above-described embodiments may, in some embodiments, be implemented in software. An embodiment provides a computer program product comprising at least one computer-readable storage medium having computer-executable program code instructions stored therein. The computer-executable program code instructions comprise computer program code for performing the above-described methods or the operations of the above-described apparatuses.

### APPENDIX I

### Quantization Issues

Assume that the following 2-D 4×4 transform has been carried out:

Y=CₘXRₘ^{T}

Thus, Y(i, j) contains the transform coefficients. Here, Cₘ and Rₘ would be either the integer cosine transform used in H.264/AVC or the integer ODST-3 (KLT) presented above.

Quantization is performed using the following formula:

Y_{q}(i,j)=sign{Y(i,j)}└(|Y(i,j)|A(C,R,Q_{M},i,j)+f2^{QS(C,R)+Q}^{_{E}})>>(QS(C,R)+Q_{E})┘

If QP (0-51) is the quantization parameter used, then Q_{M}=QP mod 6 and

$${Q}_{E} = floor ( \frac{QP}{6} ) .$$

Also, A(C,R,Q_{M},i,j) is a scaling factor that depends on the row transform used (R), column transform used (C), Q_{M}, and the location of the coefficient (i,j). f is a parameter that controls that size of the quantization deadzone. QS(C,R) is the number of bits to be shifted down by when performing quantization and depends on the column and row transform used. Thus, the quantization process does not require any division, and all the scaling that is required by the transform is absorbed into A(.).

Similarly, de-quantization is performed using the following:

Yᵣ(i,j)=Y_{q}(i,j)B(C,R,Q_{M},i,j)<<Q_{E}

Here, B(C,R,Q_{M},i,j) is a scaling factor used for de-quantization. The process is still not complete; after the inverse transform is performed, an additional bitshift of DQS(C,R) is needed.

The table below shows the values used for QS(.) and DQS(.). Note that for the case where the DCT is used for both row and column, it defaults to the H.264/AVC choices.

| Column Transform | Row Transform | QS(C, R) | DQS(C, R) |
|---|---|---|---|
| DCT | DCT | 15 | 6 |
| DCT | KLT | 17 | 9 |
| KLT | DCT | 17 | 9 |
| KLT | KLT | 19 | 12 |

The pseudo-code below shows the values used for A(.) and B(.). Again, for the case of DCT being used as the row and column transforms, the values default to those in H.264/AVC.

```
int A[4][6][16] =
{ // Row Col
  // 0 − DCT × DCT (QuantPrec = 15)
  {
    {
```

| | | | |
|---|---|---|---|
| 13107, | 8066, | 13107, | 8066, |
| 8066, | 5243, | 8066, | 5243, |
| 13107, | 8066, | 13107, | 8066, |
| 8066, | 5243, | 8066, | 5243, |

```
    },
    {
```

| | | | |
|---|---|---|---|
| 11916, | 7490, | 11916, | 7490, |
| 7490, | 4660, | 7490, | 4660, |
| 11916, | 7490, | 11916, | 7490, |
| 7490, | 4660, | 7490, | 4660, |

```
    },
    {
```

| | | | |
|---|---|---|---|
| 10082, | 6554, | 10082, | 6554, |
| 6554, | 4194, | 6554, | 4194, |
| 10082, | 6554, | 10082, | 6554, |
| 6554, | 4194, | 6554, | 4194, |

```
    },
    {
```

| | | | |
|---|---|---|---|
| 9362, | 5825, | 9362, | 5825, |
| 5825, | 3647, | 5825, | 3647, |
| 9362, | 5825, | 9362, | 5825, |
| 5825, | 3647, | 5825, | 3647, |

```
    },
    {
```

| | | | |
|---|---|---|---|
| 8192, | 5243, | 8192, | 5243, |
| 5243, | 3355, | 5243, | 3355, |
| 8192, | 5243, | 8192, | 5243, |
| 5243, | 3355, | 5243, | 3355, |

```
    },
    {
```

| | | | |
|---|---|---|---|
| 7282, | 4559, | 7282, | 4559, |
| 4559, | 2893, | 4559, | 2893, |
| 7282, | 4559, | 7282, | 4559, |
| 4559, | 2893, | 4559, | 2893, |

```
    },
  },
  // 1 − DCT × DST (QuantPrec = 15+2)
  {
    {
```

| | | | |
|---|---|---|---|
| 8779, | 5371, | 8779, | 5371, |
| 8779, | 5371, | 8779, | 5371, |
| 8779, | 5371, | 8779, | 5371, |
| 8779, | 5371, | 8779, | 5371, |

```
    },
    {
```

| | | | |
|---|---|---|---|
| 7609, | 5072, | 7609, | 5072, |
| 7609, | 5072, | 7609, | 5072, |
| 7609, | 5072, | 7609, | 5072, |
| 7609, | 5072, | 7609, | 5072, |

```
    },
    {
```

| | | | |
|---|---|---|---|
| 6714, | 4348, | 6714, | 4348, |
| 6714, | 4348, | 6714, | 4348, |
| 6714, | 4348, | 6714, | 4348, |
| 6714, | 4348, | 6714, | 4348, |

```
    },
    {
```

| | | | |
|---|---|---|---|
| 6007, | 3970, | 6007, | 3970, |
| 6007, | 3970, | 6007, | 3970, |
| 6007, | 3970, | 6007, | 3970, |
| 6007, | 3970, | 6007, | 3970, |

```
    },
    {
```

| | | | |
|---|---|---|---|
| 5435, | 3382, | 5435, | 3382, |
| 5435, | 3382, | 5435, | 3382, |
| 5435, | 3382, | 5435, | 3382, |
| 5435, | 3382, | 5435, | 3382, |

```
    },
    {
```

| | | | |
|---|---|---|---|
| 4755, | 3043, | 4755, | 3043, |
| 4755, | 3043, | 4755, | 3043, |
| 4755, | 3043, | 4755, | 3043, |
| 4755, | 3043, | 4755, | 3043, |

```
    },
    },
  // 2 − DST × DCT (QuantPrec = 15+2)
  {
    {
```

| | | | |
|---|---|---|---|
| 8779, | 8779, | 8779, | 8779, |
| 5371, | 5371, | 5371, | 5371, |
| 8779, | 8779, | 8779, | 8779, |
| 5371, | 5371, | 5371, | 5371, |

```
    },
    {
```

| | | | |
|---|---|---|---|
| 7609, | 7609, | 7609, | 7609, |
| 5072, | 5072, | 5072, | 5072, |
| 7609, | 7609, | 7609, | 7609, |
| 5072, | 5072, | 5072, | 5072, |

```
    },
    {
```

| | | | |
|---|---|---|---|
| 6714, | 6714, | 6714, | 6714, |
| 4348, | 4348, | 4348, | 4348, |
| 6714, | 6714, | 6714, | 6714, |
| 4348, | 4348, | 4348, | 4348, |

```
    },
    {
```

| | | | |
|---|---|---|---|
| 6007, | 6007, | 6007, | 6007, |
| 3970, | 3970, | 3970, | 3970, |
| 6007, | 6007, | 6007, | 6007, |
| 3970, | 3970, | 3970, | 3970, |

```
    },
    {
```

| | | | |
|---|---|---|---|
| 5435, | 5435, | 5435, | 5435, |
| 3382, | 3382, | 3382, | 3382, |
| 5435, | 5435, | 5435, | 5435, |
| 3382, | 3382, | 3382, | 3382, |

```
    },
    {
```

| | | | |
|---|---|---|---|
| 4755, | 4755, | 4755, | 4755, |
| 3043, | 3043, | 3043, | 3043, |
| 4755, | 4755, | 4755, | 4755, |
| 3043, | 3043, | 3043, | 3043, |

```
    },
  },
  // 3 − DST × DST (QuantPrec = 15+4)
  {
    {
```

| | | | |
|---|---|---|---|
| 5846, | 5846, | 5846, | 5846, |
| 5846, | 5846, | 5846, | 5846, |
| 5846, | 5846, | 5846, | 5846, |
| 5846, | 5846, | 5846, | 5846, |

```
    },
    {
```

| | | | |
|---|---|---|---|
| 5230, | 5230, | 5230, | 5230, |
| 5230, | 5230, | 5230, | 5230, |
| 5230, | 5230, | 5230, | 5230, |
| 5230, | 5230, | 5230, | 5230, |

```
    },
    {
```

| | | | |
|---|---|---|---|
| 4517, | 4517, | 4517, | 4517, |
| 4517, | 4517, | 4517, | 4517, |
| 4517, | 4517, | 4517, | 4517, |
| 4517, | 4517, | 4517, | 4517, |

```
    },
    {
```

| | | | |
|---|---|---|---|
| 4141, | 4141, | 4141, | 4141, |
| 4141, | 4141, | 4141, | 4141, |
| 4141, | 4141, | 4141, | 4141, |
| 4141, | 4141, | 4141, | 4141, |

```
    },
    {
```

| | | | |
|---|---|---|---|
| 3549, | 3549, | 3549, | 3549, |
| 3549, | 3549, | 3549, | 3549, |
| 3549, | 3549, | 3549, | 3549, |
| 3549, | 3549, | 3549, | 3549, |

```
    },
    {
```

| | | | |
|---|---|---|---|
| 3206, | 3206, | 3206, | 3206, |
| 3206, | 3206, | 3206, | 3206, |
| 3206, | 3206, | 3206, | 3206, |
| 3206, | 3206, | 3206, | 3206, |

```
    },
  },
};
int B[4][6][16] =
{ // Row Col
  // 0 − DCT × DCT (DequantPrec = 6)
  {
    {
      10, 13, 10, 13,
      13, 16, 13, 16,
      10, 13, 10, 13,
      13, 16, 13, 16,
    },
    {
      11, 14, 11, 14,
      14, 18, 14, 18,
      11, 14, 11, 14,
      14, 18, 14, 18,
    },
    {
      13, 16, 13, 16,
      16, 20, 16, 20,
      13, 16, 13, 16,
      16, 20, 16, 20,
    },
    {
      14, 18, 14, 18,
      18, 23, 18, 23,
      14, 18, 14, 18,
      18, 23, 18, 23,
    },
    {
      16, 20, 16, 20,
      20, 25, 20, 25,
      16, 20, 16, 20,
      20, 25, 20, 25,
    },
    {
      18, 23, 18, 23,
      23, 29, 23, 29,
      18, 23, 18, 23,
      23, 29, 23, 29,
    },
  },
  // 1 − DCT × DST (DequantPrec = 6+3)
  {
    {
        13, 17, 13, 17,
        13, 17, 13, 17,
        13, 17, 13, 17,
        13, 17, 13, 17,
    },
    {
        15, 18, 15, 18,
        15, 18, 15, 18,
        15, 18, 15, 18,
        15, 18, 15, 18,
    },
    {
        17, 21, 17, 21,
        17, 21, 17, 21,
        17, 21, 17, 21,
        17, 21, 17, 21,
    },
    {
        19, 23, 19, 23,
        19, 23, 19, 23,
        19, 23, 19, 23,
        19, 23, 19, 23,
    },
    {
        21, 27, 21, 27,
        21, 27, 21, 27,
        21, 27, 21, 27,
        21, 27, 21, 27,
    },
    {
        24, 30, 24, 30,
        24, 30, 24, 30,
        24, 30, 24, 30,
        24, 30, 24, 30,
    },
  },
  // 2 − DST × DCT (DequantPrec = 6+3)
  {
    {
        13, 13, 13, 13,
        17, 17, 17, 17,
        13, 13, 13, 13,
        17, 17, 17, 17,
    },
    {
        15, 15, 15, 15,
        18, 18, 18, 18,
        15, 15, 15, 15,
        18, 18, 18, 18,
    },
    {
        17, 17, 17, 17,
        21, 21, 21, 21,
        17, 17, 17, 17,
        21, 21, 21, 21,
    },
    {
        19, 19, 19, 19,
        23, 23, 23, 23,
        19, 19, 19, 19,
        23, 23, 23, 23,
    },
    {
        21, 21, 21, 21,
        27, 27, 27, 27,
        21, 21, 21, 21,
        27, 27, 27, 27,
    },
    {
        24, 24, 24, 24,
        30, 30, 30, 30,
        24, 24, 24, 24,
        30, 30, 30, 30,
    },
  },
  // 3 − DST × DST (DequantPrec = 6+6)
  {
    {
        17, 17, 17, 17,
        17, 17, 17, 17,
        17, 17, 17, 17,
        17, 17, 17, 17,
    },
    {
        19, 19, 19, 19,
        19, 19, 19, 19,
        19, 19, 19, 19,
        19, 19, 19, 19,
    },
    {
        22, 22, 22, 22,
        22, 22, 22, 22,
        22, 22, 22, 22,
        22, 22, 22, 22,
    },
    {
        24, 24, 24, 24,
        24, 24, 24, 24,
        24, 24, 24, 24,
        24, 24, 24, 24,
    },
    {
        28, 28, 28, 28,
        28, 28, 28, 28,
        28, 28, 28, 28,
        28, 28, 28, 28,
    },
    {
        31, 31, 31, 31,
        31, 31, 31, 31,
        31, 31, 31, 31,
        31, 31, 31, 31,
    },
  },
};
```

1. A method for encoding video data, the method comprising:
applying one of a first transform and a second transform to at least one row of a pixel block, and applying one of the first transform and the second transform to at least one column of the pixel block, based on a prediction mode of the pixel block, to transform between residual pixel values of the pixel block and residual transform coefficients of the pixel block; and
encoding the residual transform coefficients of the pixel block to generate encoded video data.

2. The method of claim 1, wherein the transform applied to the at least one row is different to the transform applied to the at least one column based on the prediction mode of the pixel block.

3. The method of claim 1, wherein the first transform is applied to the at least one column and the second transform is applied to the at least one row when the prediction mode of the pixel block is: Mode 0—Vertical, Mode 3—Diagonal down-left, Mode 7—Vertical-left or VER to VER+8 mode.

4. The method of claim 1, wherein the second transform is applied to the at least one column and the first transform is applied to the at least one row when the prediction mode of the pixel block is: Mode 1—Horizontal, Mode 8—Horizontal-up or HOR to HOR+8 mode.

5. The method of claim 1, wherein the first transform is applied to the at least one column and the at least one row when the prediction mode of the pixel block is: Mode 4—Diagonal down-right, Mode 5—Vertical-right, Mode 6—Horizontal-down, VER-8 to VER-1 mode or HOR-7 to HOR-1 mode.

6. The method of claim 1, wherein the second transform is applied to the at least one column and the at least one row when the prediction mode of the pixel block is: Mode 2—DC.

7. The method of claim 1, wherein the first transform is a discrete sine transform.

8. The method of claim 1, wherein the first transform is a Karhunen-Loeve transform.

9. The method of claim 8, wherein the Karhunen-Loeve transform comprises a matrix selected from the group consisting of:
$${K}_{i , j}^{N} = {[ \frac{2}{\sqrt{2 N + 1}} sin ( \frac{( 2 i + 1 ) j π}{2 N + 1} ) ]}_{i , j}^{N} ,$$
where 1≦i, j≦N and the pixel block comprises N rows and/or N columns;
$${\hat{K}}_{i , j}^{N} = round ( {F}_{1} \times {[ \frac{2}{\sqrt{2 N + 1}} sin ( \frac{( 2 i + 1 ) j π}{2 N + 1} ) ]}_{i , j}^{N} ) ,$$
where 1≦i, j≦N, F₁ is a scale factor and the pixel block comprises N×N pixels; and
$${\tilde{K}}_{i , j}^{N} = round ( {F}_{2} \times {[ \frac{2}{\sqrt{2 N + 1}} sin ( \frac{( 2 i + 1 ) j π}{2 N + 1} ) ]}_{i , j}^{N} ) ,$$
where 1≦i, j≦N, F₂ is a scale factor and the pixel block comprises N×N pixels.

10-11. (canceled)

12. The method of claim 8, wherein the Karhunen-Loeve transform is selected from the group consisting of:
$$( \begin{matrix}29 & 55 & 74 & 84 \\ 74 & 74 & 0 & - 74 \\ 84 & - 29 & - 74 & 55 \\ 55 & - 84 & 74 & - 29\end{matrix} ) , \\ ( \begin{matrix}3 & 5 & 7 & 8 \\ 7 & 7 & 0 & - 7 \\ 8 & - 3 & - 7 & 5 \\ 5 & - 8 & 7 & - 3\end{matrix} ) , and \\ ( \begin{matrix}0 & 1 & 1 & 1 \\ 1 & 1 & 0 & - 1 \\ 1 & 0 & - 1 & 1 \\ 1 & - 1 & 1 & 0\end{matrix} ) .$$

13-14. (canceled)

15. The method of claim 1, wherein the second transform is a discrete cosine transform.

16. The method of claim 15, wherein the discrete cosine transform comprises:
$$( \begin{matrix}64 & 64 & 64 & 64 \\ 84 & 35 & - 35 & - 84 \\ 64 & - 64 & - 64 & 64 \\ 35 & - 84 & 84 & - 35\end{matrix} ) .$$

17. The method of claim 1, wherein the method further comprises storing the first transform and the second transform for use in transforming between the residual pixel values of the pixel block and the residual transform coefficients of the pixel block.

18. The method of claim 1, wherein the method further comprises quantizing the residual transform coefficients before encoding the residual transform coefficients.

19. The method of claim 1, wherein the method further comprises generating the pixel block by determining the difference between an original pixel block and a predicted pixel block, the predicted pixel block being a prediction of the original pixel block and being generated using the prediction mode.

20. The method of claim 19, wherein the method further comprises processing a video signal to generate the original pixel block.

21. The method of claim 1, wherein the pixel block is a residual pixel block.

22. An apparatus for encoding video data, the apparatus comprising:
a transformer configured to apply one of a first transform and a second transform to at least one row of a pixel block, and apply one of the first transform and the second transform to at least one column of the pixel block, based on a prediction mode of the pixel block, to transform between residual pixel values of the pixel block and residual transform coefficients of the pixel block; and
an encoder configured to encode the residual transform coefficients of the pixel block to generate encoded video data.

23. A computer program product comprising at least one computer-readable storage medium having computer-executable program code instructions stored therein, the computer-executable program code instructions comprising:
program code instructions for applying one of a first transform and a second transform to at least one row of a pixel block, and applying one of the first transform and the second transform to at least one column of the pixel block, based on a prediction mode of the pixel block, to transform between residual pixel values of the pixel block and residual transform coefficients of the pixel block; and
program code instructions for encoding the residual transform coefficients of the pixel block to generate encoded video data.
